(19) United States
(12) Patent Application Publication
(10) Pub. No.: US 2016/0266739 A1
(43) Pub. Date: Sep. 15, 2016

(54) User Interface for Fleet Management

(71) Applicant: Caterpillar Inc., Peoria, IL (US)

(72) Inventors: Keith R. Folken, West Peoria, IL (US); Girish Revankar, Thane (IN); Madhavan Babu, Chennai (IN); Praveen Rajendran, Chennai (IN); Murthy RT, Chennai (IN); Prakash Kasiviswanathan, Chennai (IN); Sripriya Venkatesh Prasad, Chennai (IN); Karthick Shanmugam, Chennai (IN)

(73) Assignee: Caterpillar Inc., Peoria, IL (US)

(21) Appl. No.: 14/843,087

(22) Filed: Sep. 2, 2015

Related U.S. Application Data
(60) Provisional application No. 62/132,803, filed on Mar. 13, 2015.

(51) Int. Cl. G06F 3/0482; G06F 3/0484

(52) U.S. Cl. CPC G06F 3/0482; G06F 3/04847

(57) ABSTRACT

A user interface is provided for a fleet management web portal for a manufacturer, operator, or user to manage a fleet of equipment and/or machines. The fleet of equipment and/or machines may be linked with the fleet management web portal and the manufacturer, operator, or user may access alerts and other information associated with the equipment and/or machines using an electronic device. The user interface is compatible with electronic devices of various sizes and enables a user to interact with information associated with fleet of equipment and/or machines.

### CROSS-REFERENCE TO RELATED APPLICATION

This patent application claims the priority benefit of U.S. Provisional Patent Application No. 62/132,803, filed Mar. 13, 2015, which is incorporated herein in its entirety by this reference.

### TECHNICAL FIELD

This disclosure relates generally to a user interface for a management solution and more particularly to a graphical user interface for a fleet management web portal.

### BACKGROUND

Fleet operators may employ logs or records to keep track of a location or service records of their machines and equipment. In instances where operators need to manage a large fleet of machines and equipment, operators may employ data systems to manage the fleet within a user interface.

U.S. Patent Application Publication 2002/0178147 to Arroyo et al. discloses a user interface for organizing service jobs for a fleet of vehicles. However, the user interface of Arroyo et al. generally displays textual information in a grid format which may be difficult to read or navigate, especially when displayed on a small screen or a mobile device. Accordingly, there is a need for an improved graphical user interface.

### SUMMARY

In one aspect, the disclosure describes a display device for displaying a graphical user interface of a fleet management system. The graphical user interface includes a first screen configured to display a first panel, a second panel, and a third panel with fleet information. The graphical user interface includes one or more selection buttons or links configured to access at least a second screen, and the second screen is configured to facilitate management of one or more pieces of equipment associated with a fleet. The second screen has a panel with a plurality of menu buttons including at least one of a status parameter menu button, a fault code menu button, a fuel menu button, a power menu button, an alerts menu button, a tracking points menu button, and an equipment menu button.

In one aspect, the disclosure describes a computer-implemented method for displaying a management system through a graphical user interface on a display device. The method includes retrieving information from one or more pieces of equipment associated with the management system. The method includes generating a first screen to display a first panel including equipment information, and to display one or more selection buttons or links configured to access a second screen to facilitate management of one or more pieces of equipment associated with the management system. The method further includes generating a second screen, upon selection of the one or more selection buttons or links configured to access a second screen, to display a panel having one or more of a status parameter menu button, a fault code menu button, a fuel menu button, a power menu button, an alerts menu button, a tracking points menu button, and an equipment menu button.

### BRIEF DESCRIPTION OF THE DRAWINGS

FIG. 1 shows an exemplary user interface for a home screen page in accordance with aspects of the present disclosure.

FIG. 2 shows an exemplary user interface for a fleet screen page with a list of selectable equipment in accordance with aspects of the present disclosure.

FIG. 3 shows an enlarged portion of the exemplary user interface of FIG. 2.

FIG. 4 shows an exemplary user interface for a fleet screen page displaying device information for a selected asset or piece of equipment in accordance with aspects of the disclosure.

FIG. 5 shows an exemplary user interface for a fleet screen page displaying tracking points for a selected asset or piece of equipment in accordance with aspects of the disclosure.

FIG. 6 shows an exemplary user interface for a fleet screen page displaying detailed tracking point information for a selected asset or piece of equipment in accordance with aspects of the disclosure.

FIG. 7 shows an exemplary user interface for a fleet screen page displaying an expanded second panel in accordance with aspects of the disclosure.

FIG. 8 shows an exemplary user interface for a fleet screen page displaying a collapsed second panel in accordance with aspects of the disclosure.

FIG. 9 shows an exemplary user interface for a fleet screen page displaying status parameters information for a selected asset or piece of equipment in accordance with aspects of the disclosure.

FIG. 10 shows an exemplary user interface for a fleet screen page displaying fault codes information for a selected asset or piece of equipment in accordance with aspects of the disclosure.

FIG. 11 shows an exemplary user interface for a fleet screen page displaying fuel information for a selected asset or piece of equipment in accordance with aspects of the disclosure.

FIG. 12 shows an exemplary user interface for a fleet screen page displaying power information for a selected asset or piece of equipment in accordance with aspects of the disclosure.

FIG. 13 shows a first exemplary user interface for a fleet screen page displaying alerts information for a selected complex asset in accordance with aspects of the disclosure.

FIG. 14 shows a second exemplary user interface for a fleet screen page displaying alerts information for a selected asset or piece of equipment in accordance with aspects of the disclosure.

FIG. 15 shows a first exemplary user interface for a fleet screen page displaying alerts information for a selected complex marine asset in accordance with aspects of the disclosure.

FIG. 16 shows a second exemplary user interface for a fleet screen page displaying alerts information for a selected marine asset in accordance with aspects of the disclosure.

FIG. 17 shows an exemplary user interface for a fleet screen page displaying configurable tabs or menus in accordance with aspects of the disclosure.

FIG. 18 shows an exemplary user interface for a fleet screen page displaying tracking points information for a selected asset or piece of equipment in accordance with aspects of the disclosure.

FIG. 19 shows an exemplary user interface for a fleet screen page displaying equipment information for a selected asset or piece of equipment in accordance with aspects of the disclosure.

FIG. 20 shows an exemplary user interface for a manage view assignment page in accordance with aspects of the disclosure.

FIG. 21 shows an exemplary user interface for an edit view assignment page in accordance with aspects of the disclosure.

FIG. 22 shows an exemplary user interface for an expiration and viewer selection page in accordance with aspects of the disclosure.

FIG. 23 shows an exemplary user interface for a view assignment confirmation page in accordance with aspects of the disclosure.

FIGS. 24 and 25 show an exemplary user interface for an administrative screen page displaying a switch input configuration and alert manager in accordance with aspects of the disclosure.

FIG. 26 shows a block diagram of an exemplary fleet management system in accordance with aspects of the disclosure.

FIG. 27 shows a schematic diagram of an exemplary computer system in accordance with aspects of the disclosure.

### DETAILED DESCRIPTION

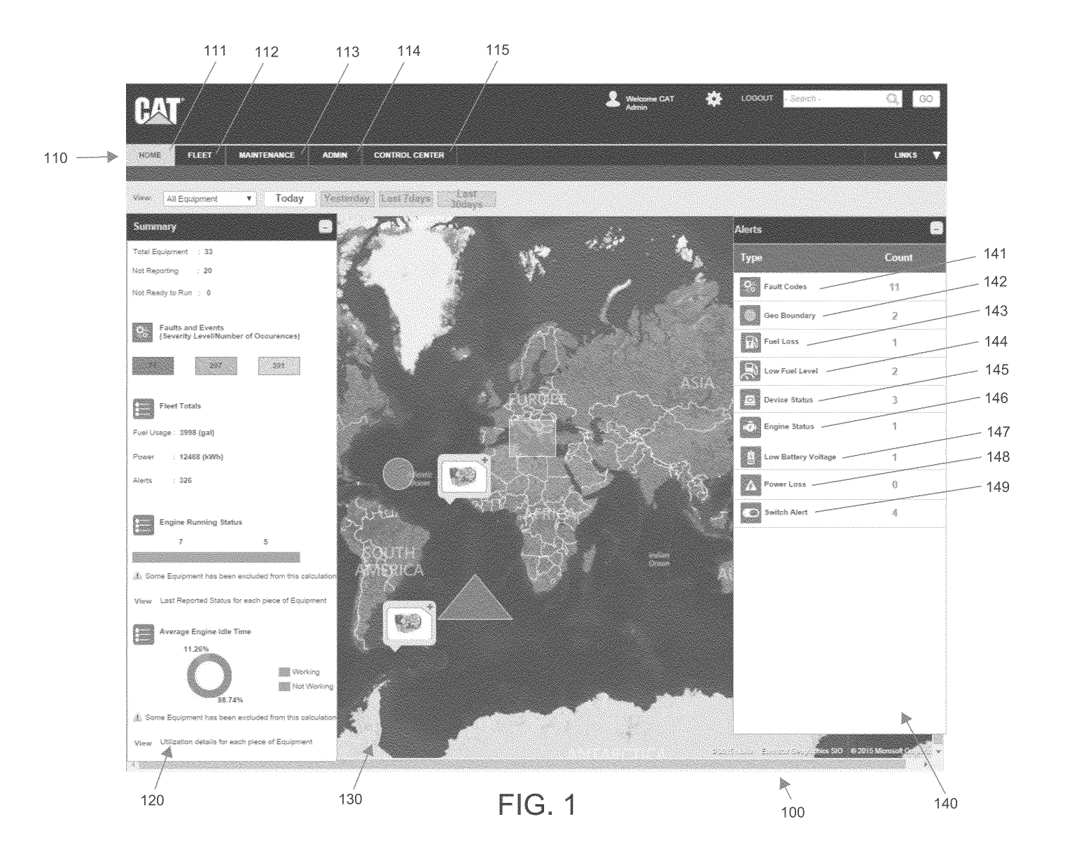

Now referring to the drawings, wherein like reference numerals refer to like elements, FIG. 1 shows a general graphical user interface layout for a home screen page 100 of a management solution portal or a fleet management web portal. The fleet management web portal may include an interactive interface, and may further include or may be connected to a database hosted on one or more servers located at one or more sites. The fleet management web portal may be used to store, receive and/or distribute data and information relating to a single piece of machine or equipment, a fleet of machines and equipment, or a plurality of fleets of machines and equipment associated with one or more parties. The fleet management web portal may enable operators to access relevant and up-to-date information relating to their machines and equipment to improve operating efficiency and to reduce cost. The fleet management web portal may enable manufacturers, operators, and service providers to coordinate maintenance, repairs, and/or upgrades of the machines or the equipment.

The manufacturers, operators, and service providers may connect to and access the management solution portal or fleet management web portal, which may include an application that is executable on computer hardware, such as a microprocessor, or may be an application that is executable over one or more of a local-area network, peer-to-peer network, a wide-area network, a cloud-based network, etc. In one aspect, the fleet management web portal may be a part of a website or web application.

In one aspect, the fleet management web portal may be accessed with an electronic device, such as but not limited to, a desktop computer, a laptop, a tablet, a mobile phone, etc. The electronic device may establish a wired or wireless connection on a communication channel with at least one server hosting an interface and/or a database associated with the fleet management web portal. The electronic device may retrieve information from one or more pieces of equipment associated with the fleet management web portal. The electronic device may include at least a display device or screen and at least one input device. In one aspect, the at least one input device may include one or more of a keyboard, a mouse, a button, a touchpad, a touchscreen, or the like. In one aspect, the display screen and the at least one input device may be a touch-screen display to display images and to receive inputs and gestures performed on a surface of the display screen.

The home screen page 100 may include a first row of selection links, buttons, or tabs 110 associated with primary sections of the management solution portal or a fleet management web portal. The home screen page 100 may include a first panel 120, a second panel 130, and a third panel 140. The first panel 120 may be used to display equipment summary alerts and/or equipment operating parameters. The first panel 120 may graphically show a percentage of engines in a working state and in a not working state. The first panel 120 may display fleet totals, which may include one or more of a total fuel usage, a total power usage, and a total number of alerts. The second panel 130 may be used to display a map, which may contain equipment information relating to the equipment summary alerts and/or equipment operating parameters. The equipment information may be overlaid on the map in the second panel 130 to provide a visual representation of a location of each asset. The third panel 140 may be used to display a list of alert types and a numerical count of each alert type that has an active alert. In one aspect, the first panel 120, the second panel 130, and/or the third panel 140 may be vertically oriented such that their respective height is greater than their respective width. In one aspect, the second panel 130 may be larger in size than either the first panel 120 or the third panel 140, or the second panel 130 may be sized larger than both the first panel 120 and the third panel 140 combined. In one aspect, the second panel 130 may be centrally located between the first panel 120 and the third panel 140.

Referring still to FIG. 1, the first row of selection links, buttons, or tabs 110 may include one or more of a home button 111, a fleet button 112, a maintenance button 113, an administrative or admin button 114, and a control center button 115. In one aspect, the third panel 140 may display alert information relating to the fleet of equipment and may display a numerical count of alerts. The numerical count of alerts displayed within the third panel 140, which may be divided into alert subcategories. The subcategories may include one or more of the following: fault codes 141, geographic or geo boundaries 142, the fuel loss 143, low fuel level 144, device status 145, engine status 146, low battery voltage 147, power loss 148, and switch alert 149.

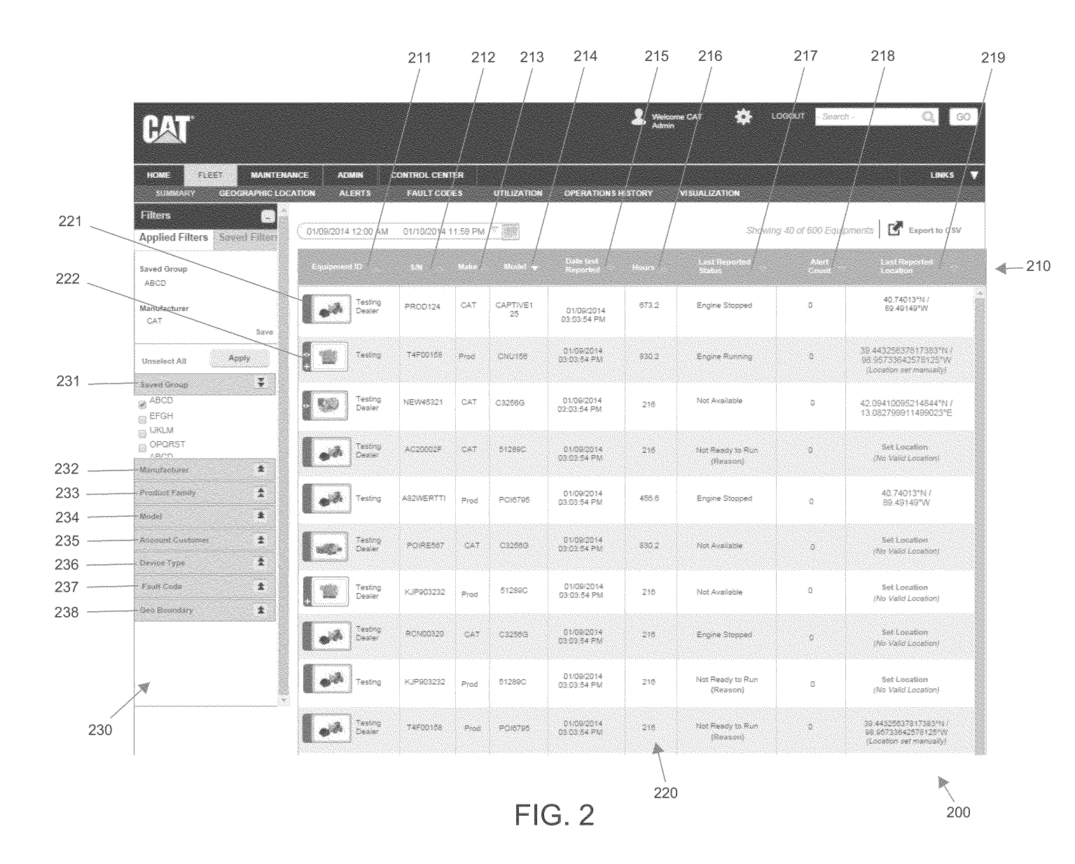

Turning to FIG. 2, a fleet screen page 200 may be accessed by selecting the fleet button 112 from at least the home screen page 100 (as shown in FIG. 1). The fleet screen page 200 may include a header 210 for organizing and arranging a list, chart, or grid of equipment in a first panel 220 of the fleet screen page 200. The header 210 may be in the form of a row and may include one or more of the following categories: equipment identification 211, serial number 212, equipment make 213, model 214, date of last report 215, hours 216, last reported status 217, alert count 218, and last reported location 219. The list of equipment shown in the first panel 220 may be sorted vertically, and the list may be scrolled vertically if the number of equipment entries exceeds the vertical space provided by a user's display device screen.

In one aspect, each of the categories shown in the header 210 may be used to sort numeric, alphanumeric, and/or textual information. In one aspect, the equipment identification 211 may be used to sort types of equipment, and the types of equipment may be shown with an icon 221 for a single asset or an icon 222 for a complex asset, which may have multiple parts capable of being monitored. In one aspect, information associated with each piece of equipment, or sub-equipment, may be displayed horizontally to increase the number of equipment entries that can be shown on the fleet screen page 200 and to enable all categories of information associated with an asset to be displayed simultaneously. In one aspect, the fleet screen page 200 may include a filter sub-panel 230 for filtering the asset or equipment to be displayed in the first panel 220. In one aspect, the filter sub-panel 230 may include one or more of the following filter options or categories: saved groups 231, manufacturer 232, product family 233, model 234, account customer 235, device type 236, fault code 237, and geographic or geo boundary 238.

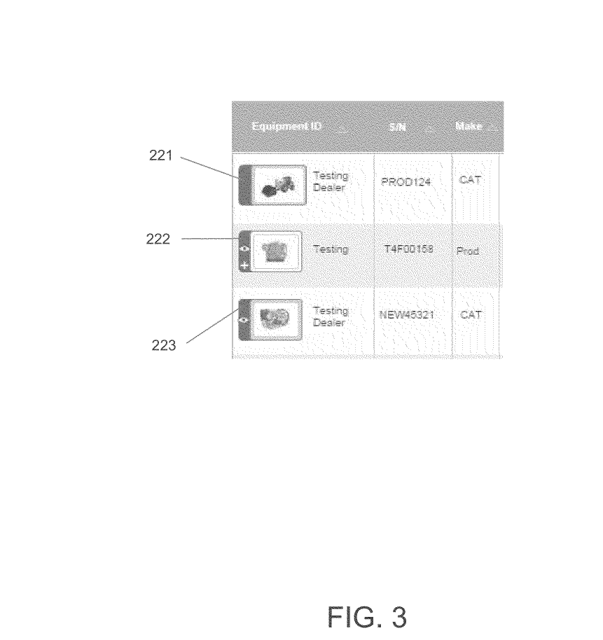

Referring to FIG. 3, an enlarged portion of the first panel 220 of FIG. 2 is shown. In one aspect, certain equipment may be classified as a complex asset and may be linked to or associated with sub-equipment or have multiple parts capable of being monitor. The complex asset may be identified with an icon 222 including a “+” sign. In one aspect, certain equipment or sub-equipment associated with view assignments or view authority, as will be described in greater detail below, may include an icon 223 with an “eye” symbol. Other symbols and/or signs are of course contemplated. Equipment or sub-equipment associated with a view assignment or view authority may enable one or more preselected viewers to see details and information associated with the piece of equipment or sub-equipment.

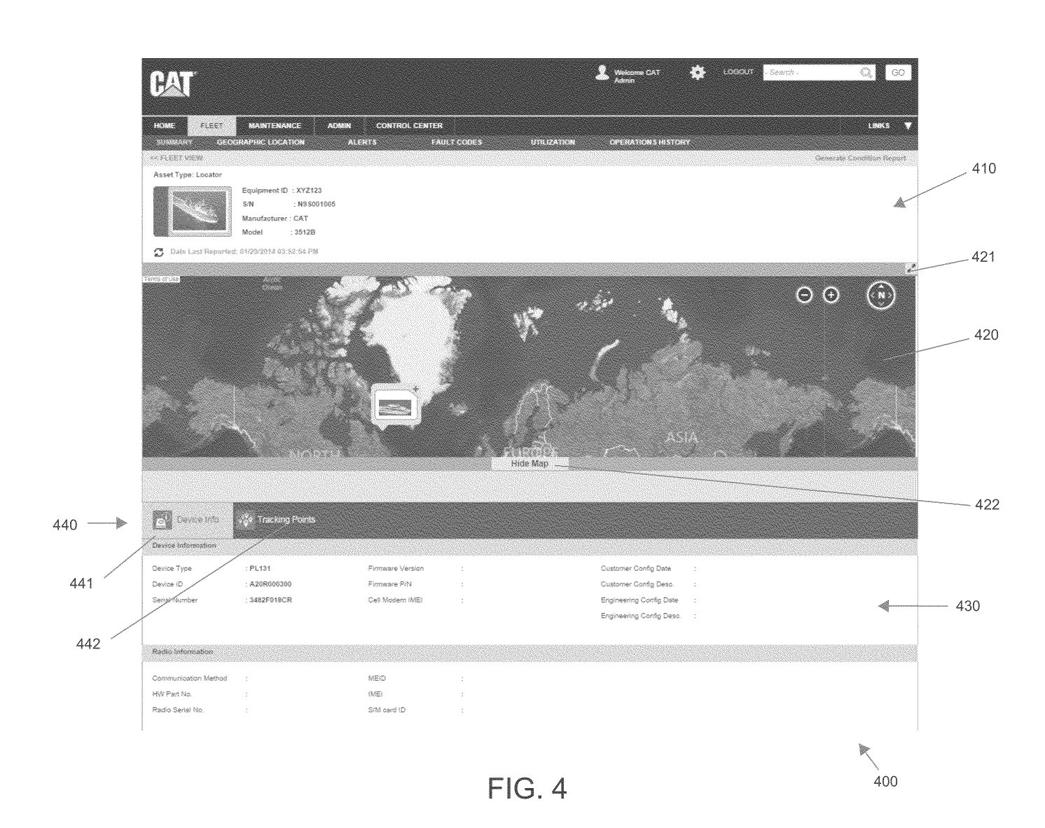

Turning to FIG. 4, a fleet screen summary page 400 may include a first panel 410, a second panel 420, and a third panel 430 to display information relating to a selected fleet asset or selected piece of equipment. The first panel 410, the second panel 420, and the third panel 430 may be stacked vertically on top of one another. In one aspect, the first panel 410 may be used to display equipment information, such as marine-based equipment information. The marine-based equipment information of the first panel 410 may include, but is not limited to, equipment identification, serial number, manufacturer, and model. The first panel 410 may be horizontally arranged such that the equipment information may be displayed simultaneously on the user's display device screen.

In one aspect, the second panel 420 may be used to display a map or geographic information. The second panel 420 may include a resize button 421 to resize, minimize, or maximize a size of the second panel 420 relative to a current size. In one aspect, the second panel 420 may include a hide map button 422 to hide the map shown in the second panel 420 and to vertically reduce the size of the second panel 420. In one aspect, the third panel 430 may include one or more links, buttons, or tabs 440 to display additional information relating to the currently selected asset or piece of equipment. In one aspect, the one or more links, buttons, or tabs 440 may include a device info button 441 and a tracking points button 442.

When the device info button 441 is selected (as shown in FIG. 4), device information and/or radio information may be displayed in the third panel 430. In one aspect, the device information may include one or more of: device type, device ID, serial number, firmware version, firmware part number, cell modem IMEI, customer configuration date, customer configuration description, engineering configuration date, and engineering configuration description. In one aspect, the radio information may include one or more of: communication method, hardware part number, radio serial number, MEID, IMEI, and SIM card ID. The third panel 430 may be horizontally arranged in order for all the device information associated with a piece of equipment to be displayed together within the user's display device screen.

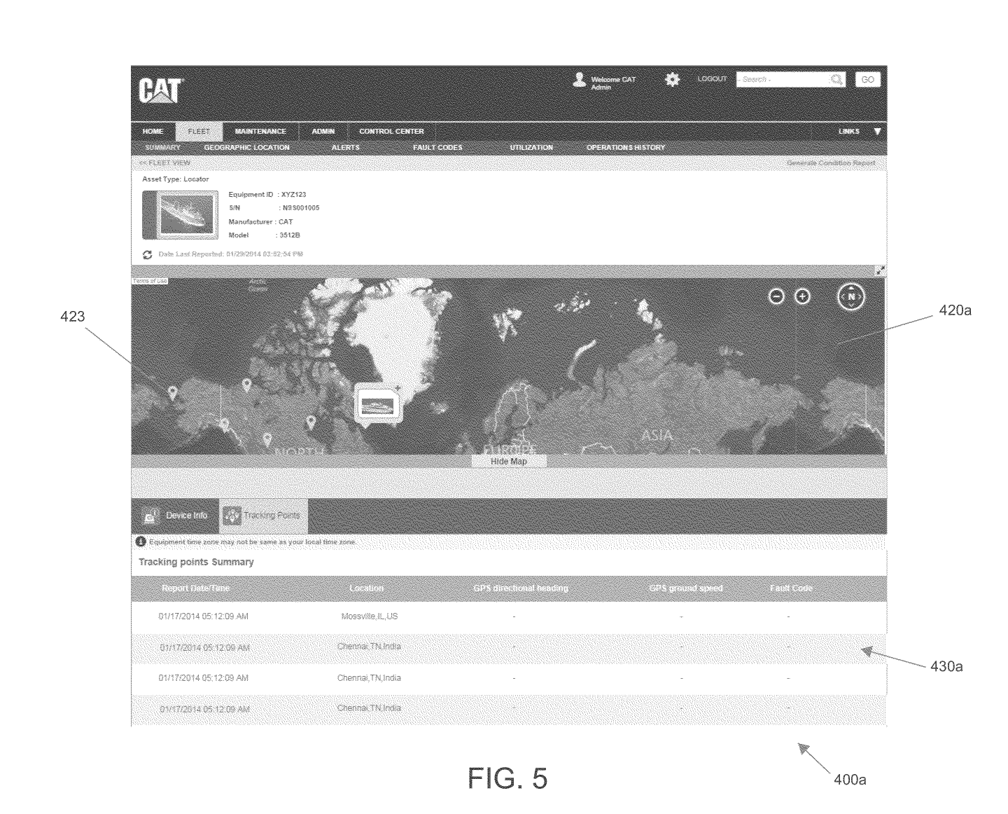

In one aspect, when the tracking points button 442 is selected (as shown in FIG. 4), a tracking points summary relating to the currently selected asset or piece of equipment may be displayed in an updated or refreshed third panel 430a of the fleet screen summary page 400a, as shown in FIG. 5. In one aspect, the third panel 430a may display a chart of tracking points summary information which may include one or more of: report date/time, location, GPS directional heading, GPS ground speed, and fault code. Additionally, corresponding markers may be displayed on an updated map in the second panel 420a. Each marker 423 may correspond to a separate entry listed in the chart of tracking points summary information shown in the third panel 430a. The third panel 430a may be horizontally arranged in order for all the tracking points information associated with a particular tracking point to be displayed together within the user's display device screen.

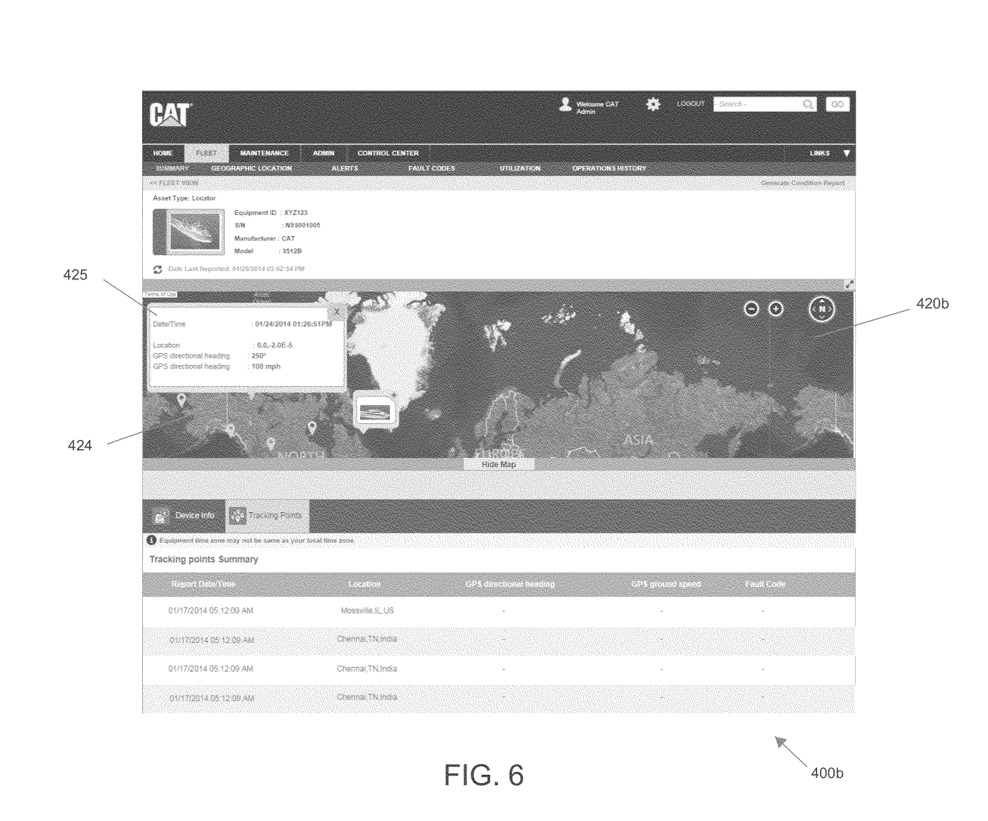

Referring to FIG. 6, when a marker 424 is selected, a pop-up window 425 may be displayed in an updated or refreshed second panel 420b of the fleet screen summary page 400b. The pop-up window 425 may display information relating to the selected marker 424. In one aspect, the pop-up window 425 may display tracking point information for the selected marker 424 and may include one or more of: date, time, location, GPS directional heading, and GPS directional heading speed.

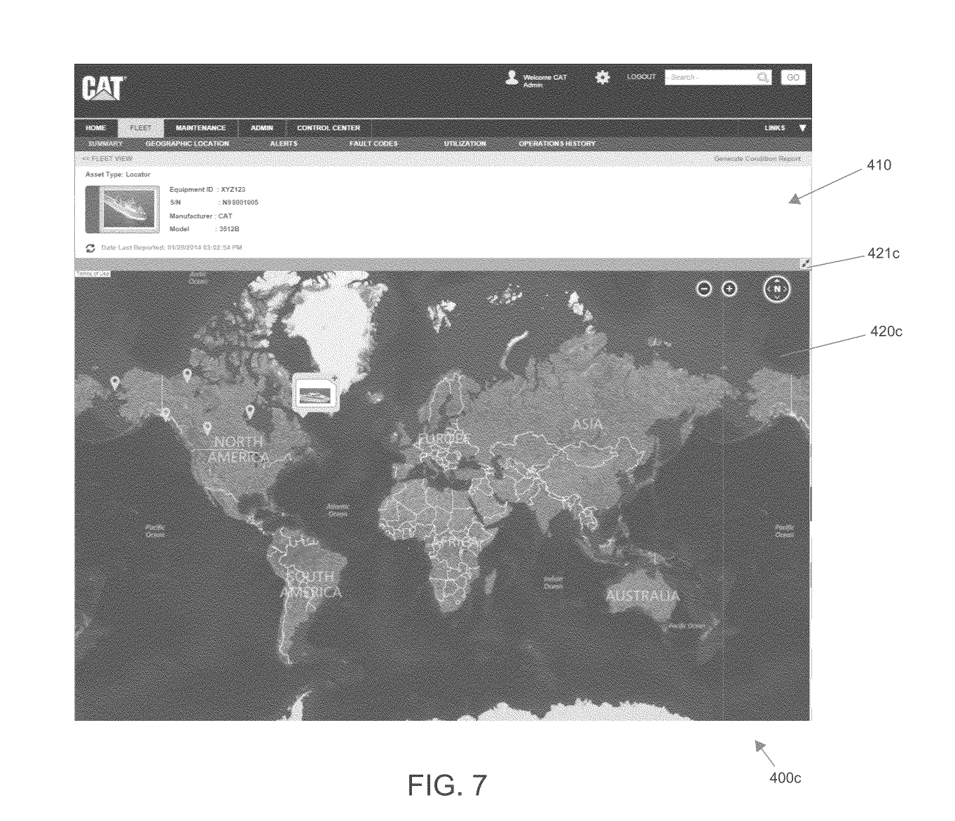

Referring to FIG. 7, when the resize button 421 is selected while in the fleet screen summary page 400 (as shown in FIG. 4), an updated or refreshed fleet screen summary page 400c may be display with an enlarged second panel 420c relative to the second panel 420 in FIG. 4. In one aspect, the enlarged second panel 420c may be used to display map or geographic information. In one aspect, the updated or refreshed fleet screen summary page 400c may include only the first panel 410 used to display equipment information and the updated or refreshed second panel 420c used to display map or geographic information. The updated or refreshed second panel 420c may extend a majority of a height of the display screen and may extend more than 50% of the height of the user's display device screen. In one aspect, the updated or refreshed second panel 420c may extend greater than 75% of the height of the display screen. In one aspect, the updated or refreshed fleet screen summary page 400c may include a resize button 421c, which may be selected to resize or minimize the enlarged second panel 420c. For example, selection of the resize button 421c may refresh the screen to display the second panel 420 and fleet screen summary page 400, as shown in FIG. 4.

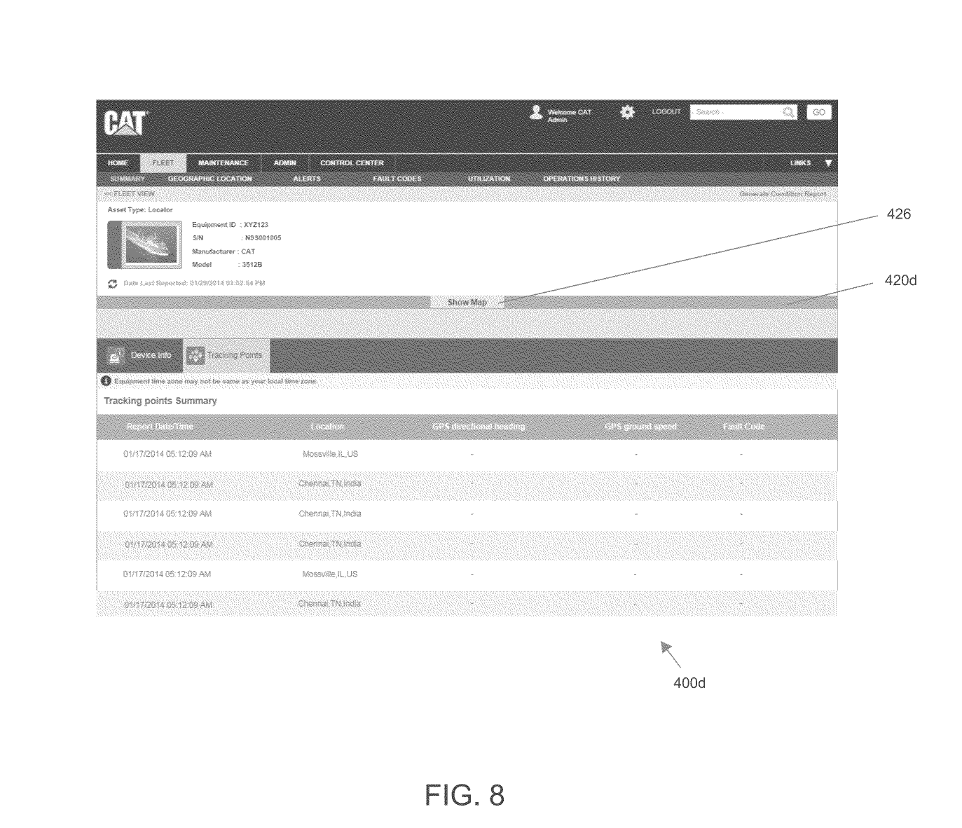

Referring to FIG. 8, when the hide map button 422 is selected while in the fleet screen summary page 400 (as shown in FIG. 4), an updated or refreshed fleet screen summary page 400d may be display with a collapsed second panel 420d relative to the second panel 420 in FIG. 4. In one aspect, the collapsed second panel 420d may be collapsed to hide any information previously displayed in the second panel 420 of FIG. 4. For example, if the second panel 420 of FIG. 4 was used to display a map, the map may be collapsed and hidden in the collapsed second panel 420d. In one aspect, the collapsed second panel 420d may include a show map button 426, which may be selected to resize or maximize the collapsed second panel 420d. For example, selection of the show map button 426 may refresh the screen to display the second panel 420 and fleet screen summary page 400, as shown in FIG. 4.

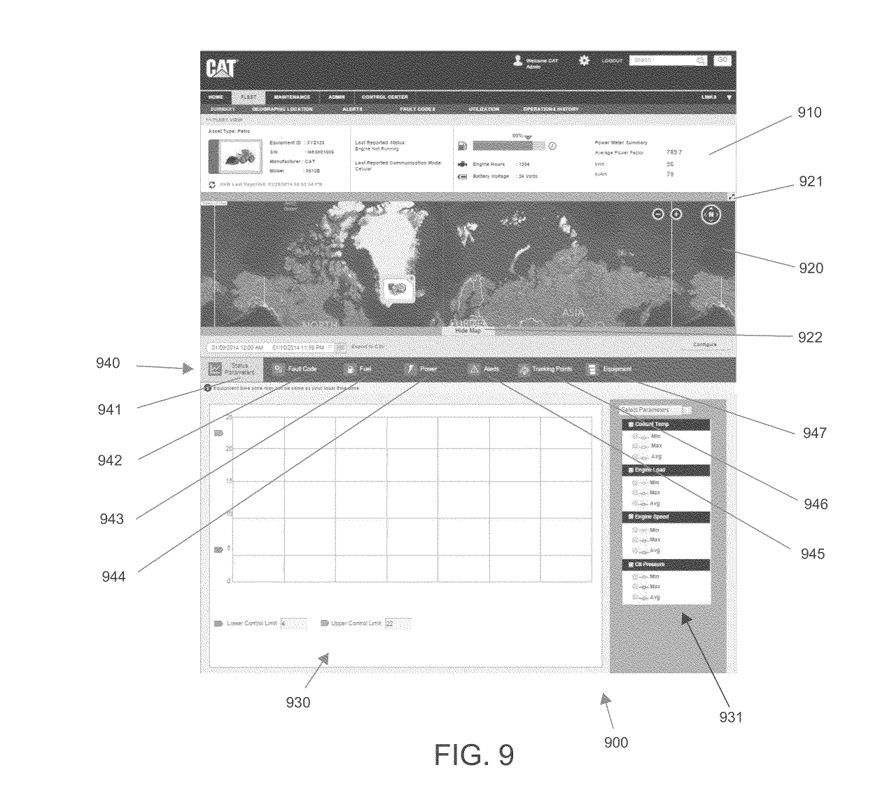

Turning to FIG. 9, a fleet screen summary page 900 according to a second embodiment is shown. The fleet screen summary page 900 may include a fleet first panel 910, a fleet second panel 920, and a fleet third panel 930 to display information relating to a selected fleet asset or selected piece of equipment. The fleet first panel 910, the fleet second panel 920, and the fleet third panel 930 may be stacked vertically on top of one another. In one aspect, the fleet first panel 910 may be used to display equipment information, which may include land-based machine information such as, but not limited to, equipment identification (ID), serial number, manufacturer, model, last reported status, last reported communication mode, fuel amount, engine hours, battery voltage, power meter summary, average power factor, energy consumption amount (kWh), and reactive power amount (kVArh). The fleet first panel 910 may be horizontally arranged such that the equipment information may be displayed simultaneously on the user's display device screen.

In one aspect, the fleet second panel 920 may be used to display a map or geographic information. In one aspect of the fleet second panel 920, may include a resize button 921 to resize, minimize, or maximize a size of the fleet second panel 920 relative to a current size. In one aspect, the fleet second panel 920 may include a hide map button 922 to hide the map shown in the fleet second panel 920 and to vertically reduce the size of the fleet second panel 920. In one aspect, the fleet third panel 930 may include one or more tabs or menu buttons 940 to display additional information relating to the currently selected asset or piece of equipment. In one aspect, the one or more tabs or menu buttons 940 may include one or more of a status parameter menu button 941, a fault code menu button 942, a fuel menu button 943, a power menu button 944, an alerts menu button 945, a tracking points menu button 946, and an equipment menu button 947. In one aspect, the fleet screen summary page 900 may be configured such that the tabs or menu buttons 940 are displayed on the user's display device screen without having to scroll downward upon arrival to the fleet screen summary page 900. In one aspect, the fleet screen summary page 900 may be configured for a landscape orientation and may simultaneous display the fleet first panel 910, the fleet second panel 920, and at least the one or more tabs or menu buttons 940 of the fleet third panel 930.

In one aspect, when the status parameter menu 941 is selected, status parameter information relating to the currently selected asset or piece of equipment may be displayed in the fleet third panel 930. The fleet third panel 930 may include a graph or plot of past or real-time status parameters. In one aspect, the fleet third panel 930 may include a status parameter sub-panel 931, which may include one or more check boxes or toggles for selecting one or more status parameter categories including: coolant temperature, engine load, engine speed, and oil pressure. Each of the status parameter categories may include a selection to display one or more of a minimum, maximum, and average plot of the respective status parameter category. In one aspect, each of the selected status parameters may be displayed on the graph or plot in the fleet third panel 930 if information relating to the selected status parameters is available.

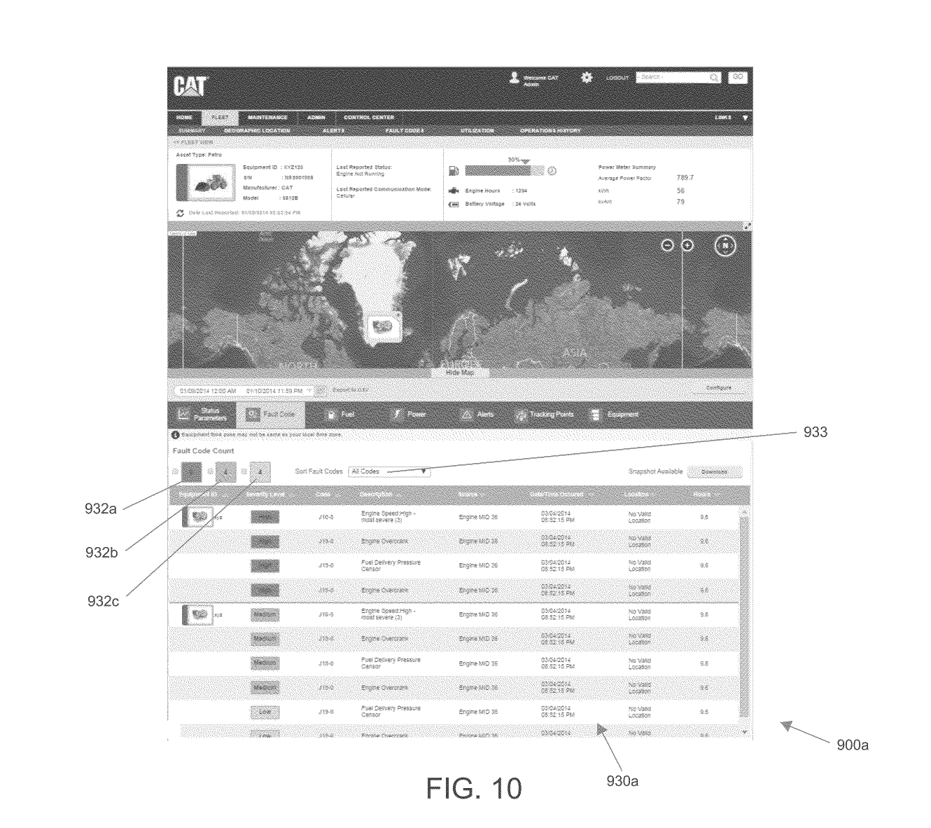

Turning to FIG. 10, when the fault code menu 942 (as shown in FIG. 9) is selected, the fault codes relating to the currently selected asset or piece of equipment may be displayed in an updated or refreshed fleet third panel 930a of a fleet screen summary page 900a. In one aspect, the fleet third panel 930a may include a chart of fault codes associated with the currently selected asset, and the chart may include one or more of the following fields: equipment ID, security level, code, description, source, date/time occurred, location, and hours. In one aspect, the fields may form a first row of the chart and each field may be selectable to sort the chart by the selected field. In one aspect, the fleet third panel 930a may include severity level selections 932a, 932b, 932c to selectively show or hide fault codes in the chart relating to high severity fault codes, medium severity fault codes, and low severity fault codes, respectively. In one aspect, the fleet third panel 930b may include a sort fault codes drop down menu 933 to allow selection of a specific type of fault code to display in the chart.

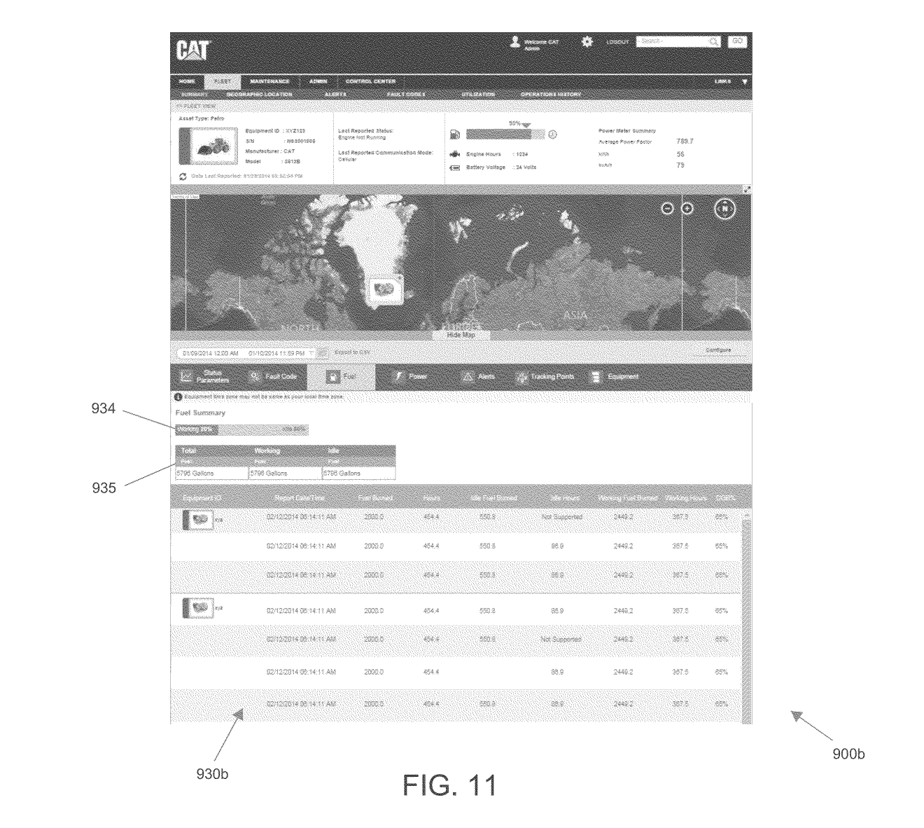

Turning to FIG. 11, when the fuel menu button 943 (as shown in FIG. 9) is selected, fuel summary information relating to the currently selected asset or piece of equipment may be displayed in an updated or refreshed fleet third panel 930b of a fleet screen summary page 900b. In one aspect, the fleet third panel 930b may include a chart showing fuel summary information for one or more pieces of equipment associated with the currently selected asset. In one aspect, the chart may include one or more of the following fields: equipment ID, report date/time, fuel burned, hours, idle fuel burned, idle hours, working fuel burned, working hours, and dynamic gas blending (DGB) percentage. In one aspect, the fleet third panel 930b may include a graphical meter 934 to visually show a breakdown of the working and idle percentage of the selected asset. In one aspect, the fleet third panel 930b may include a fuel summary section 935, which may show one or more of a total fuel amount, working fuel amount, and idle fuel amount.

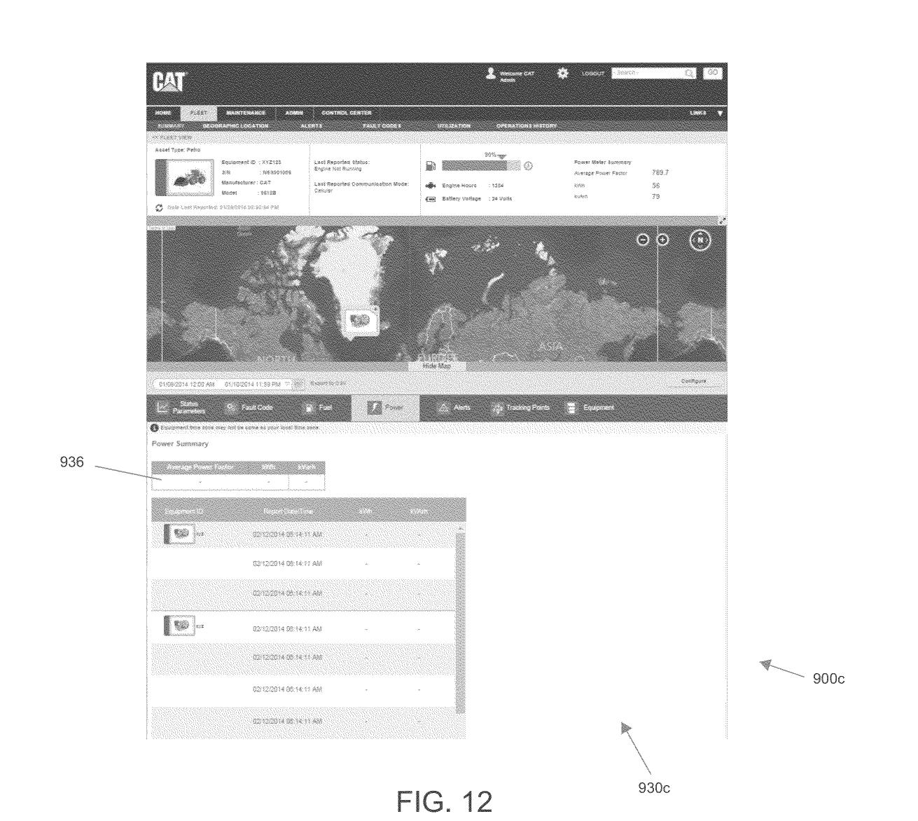

Turning to FIG. 12, when the power menu button 944 (as shown in FIG. 9) is selected, power summary information relating to the currently selected asset or piece of equipment may be displayed in an updated or refreshed fleet third panel 930c of a fleet screen summary page 900c. In one aspect, the fleet third panel 930c may include a chart showing power summary information for one or more pieces of equipment associated with the currently selected asset or piece of equipment. In one aspect, the chart may include one or more of the following fields: equipment identification (ID), report date/time, energy consumption amount (kWh), and reactive power amount (kVArh). In one aspect, the fleet third panel 930c may include a power summary section 936 which may display one or more of an average power factor, energy consumption amount (kWh), and reactive power amount (kVArh) for the selected asset or piece of equipment.

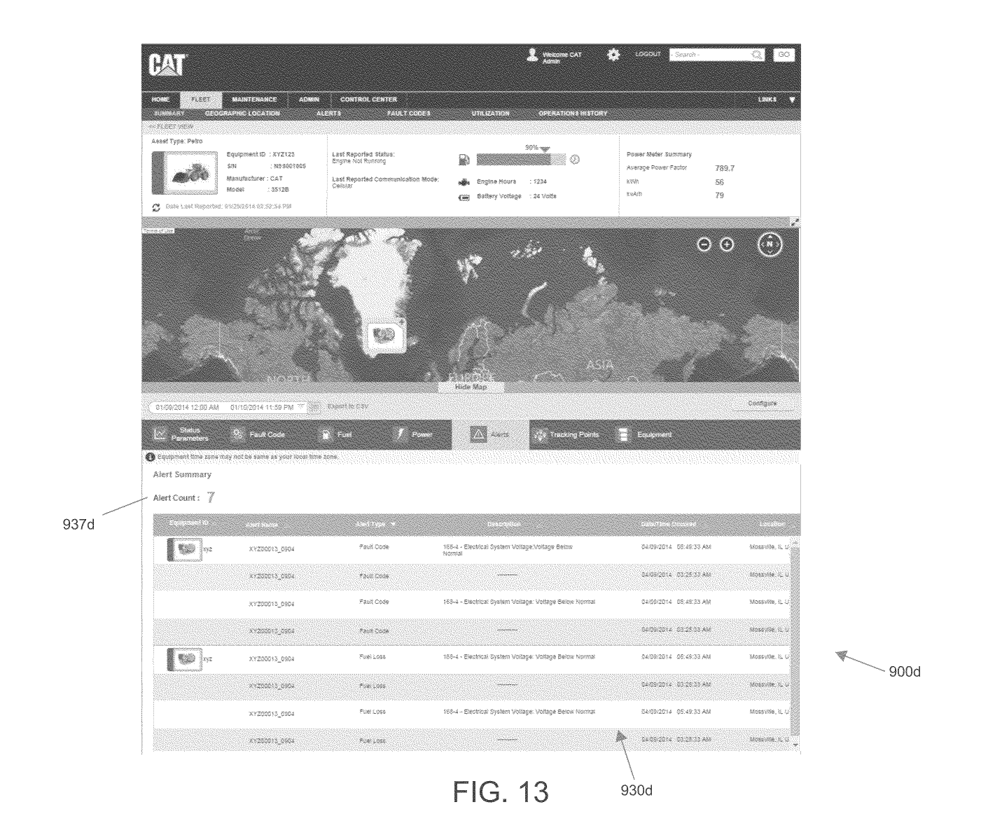

Turning to FIG. 13, when the currently selected asset is a complex asset including multiple pieces of equipment and the alerts menu button 945 (as shown in FIG. 9) is selected, alert information relating to the complex asset may be displayed in an updated or refreshed fleet third panel 930d of a fleet screen summary page 900d. In one aspect, the fleet third panel 930d may include a chart showing alert summary information for the complex asset. In one aspect, the chart may include one or more of the following fields: equipment identification (ID), alert name, alert type, description, date/time occurred, and location. In one aspect, the fleet third panel 930d may include an alert count 937d, which may display a total number of alerts associated with the complex asset.

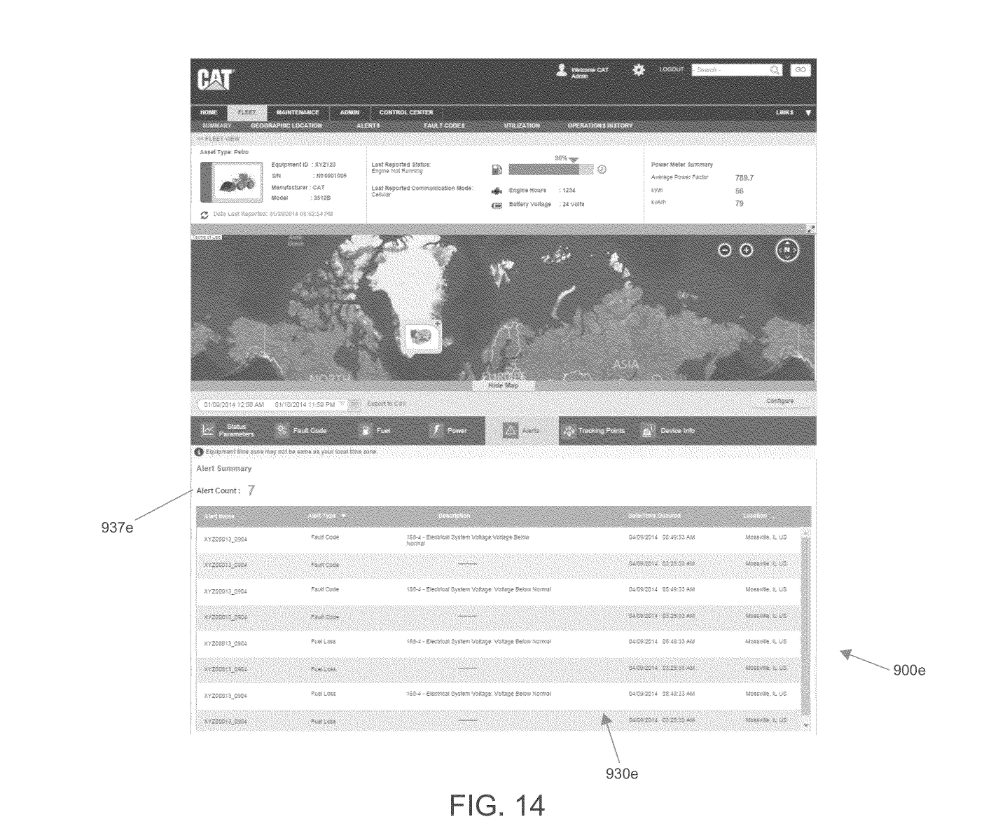

Turning to FIG. 14, when the currently selected asset is a single asset and the alerts menu button 945 (as shown in FIG. 9) is selected, alert information relating to the single asset may be displayed in an updated or refreshed fleet third panel 930e of a fleet screen summary page 900e. In one aspect, the fleet third panel 930e may include a chart showing alert summary information for the single asset. In one aspect, the chart may include one or more of the following fields: alert name, alert type, description, date/time occurred, and location. In one aspect, the fleet third panel 930e may include an alert count 937e, which may display a total number of alerts associated with the single asset.

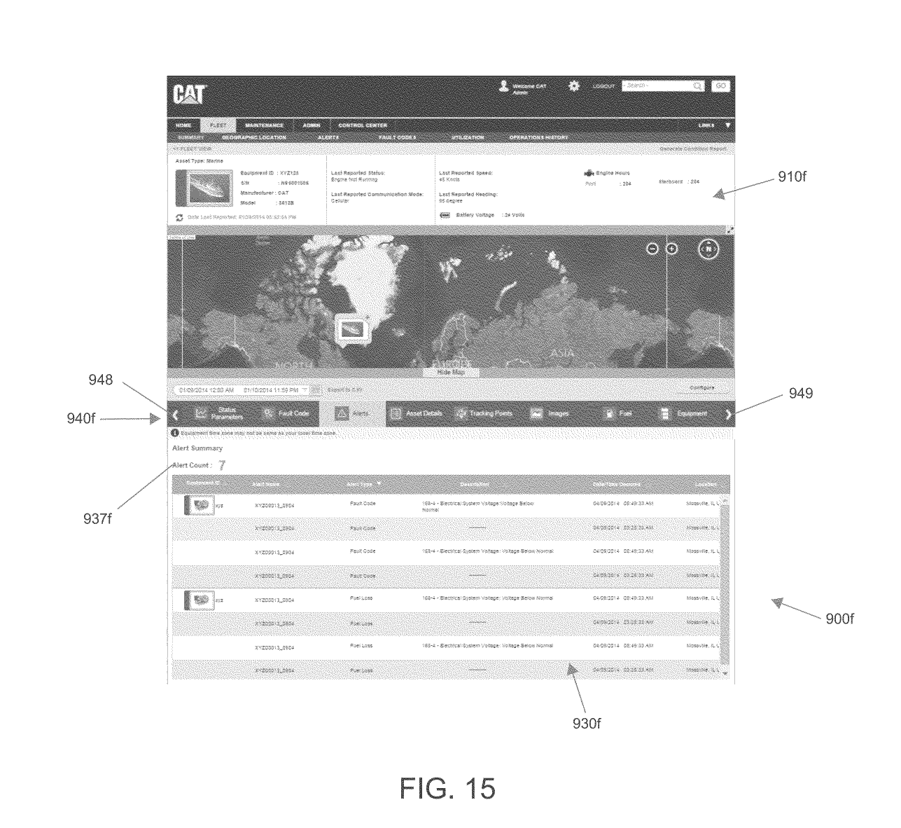

Turning to FIG. 15, when the currently selected asset is a complex marine asset and the alerts menu button 945 (as shown in FIG. 9) is selected, alert information relating to the complex marine asset may be displayed in an updated or refreshed fleet third panel 930f of the fleet screen summary page 900f. For example, the complex marine asset being monitored may include a port side engine and a starboard side engine. In one aspect, the fleet third panel 930f may include a chart showing alert summary information for the complex marine asset. In one aspect, the chart may include one or more of the following fields: equipment identification (ID), alert name, alert type, description, date/time occurred, and location. In one aspect, the fleet third panel 930f may include an alert count 937f, which may display a total number of alerts associated with the complex marine asset.

In one aspect, as shown in FIG. 15, modified tabs or menu buttons 940f may be provided depending on a width of the user's display device screen. Where a total width of all available tabs or menu buttons placed side-by-side exceeds a width of the user's display device screen, left toggle button 948 and/or right toggle button 949 may be provided in the fleet third panel 930f to laterally scroll through the available tabs or menu buttons. Marine-based equipment information may be displayed in a fleet first panel 910f, which may include, but is not limited to, equipment identification (ID), serial number, manufacturer, model, last reported status, last reported communication mode, last reported speed (in knots), last reported heading direction, battery voltage, and engine hours.

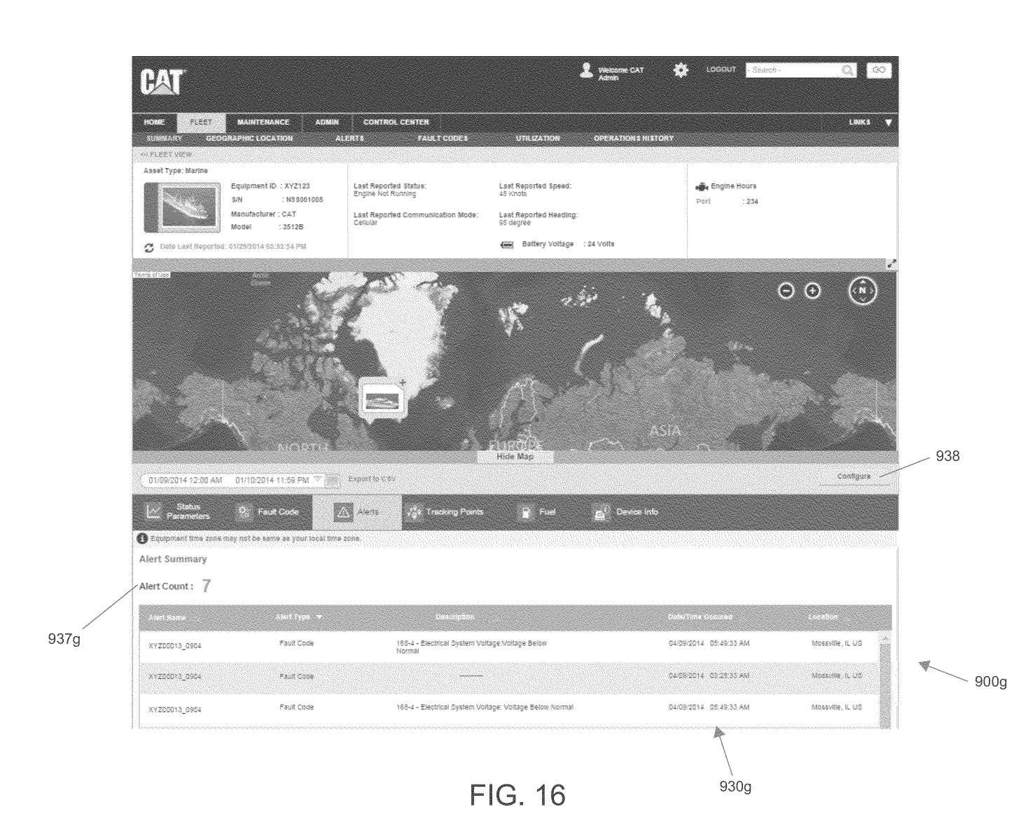

Turning to FIG. 16, when the currently selected asset is a single marine asset and the alerts menu 945 (as shown in FIG. 9) is selected, alert information relating to the single marine asset may be displayed in an updated or refreshed fleet third panel 930g of the fleet screen summary page 900g. For example, the single marine asset being monitored may include a port side engine. In one aspect, the fleet third panel 930g may include a chart showing alert summary information for the single asset. In one aspect, the chart may include one or more of the following fields: alert name, alert type, description, date/time occurred, and location. In one aspect, the fleet third panel 930g may include an alert count 937g, which may display a total number of alerts associated with the single asset.

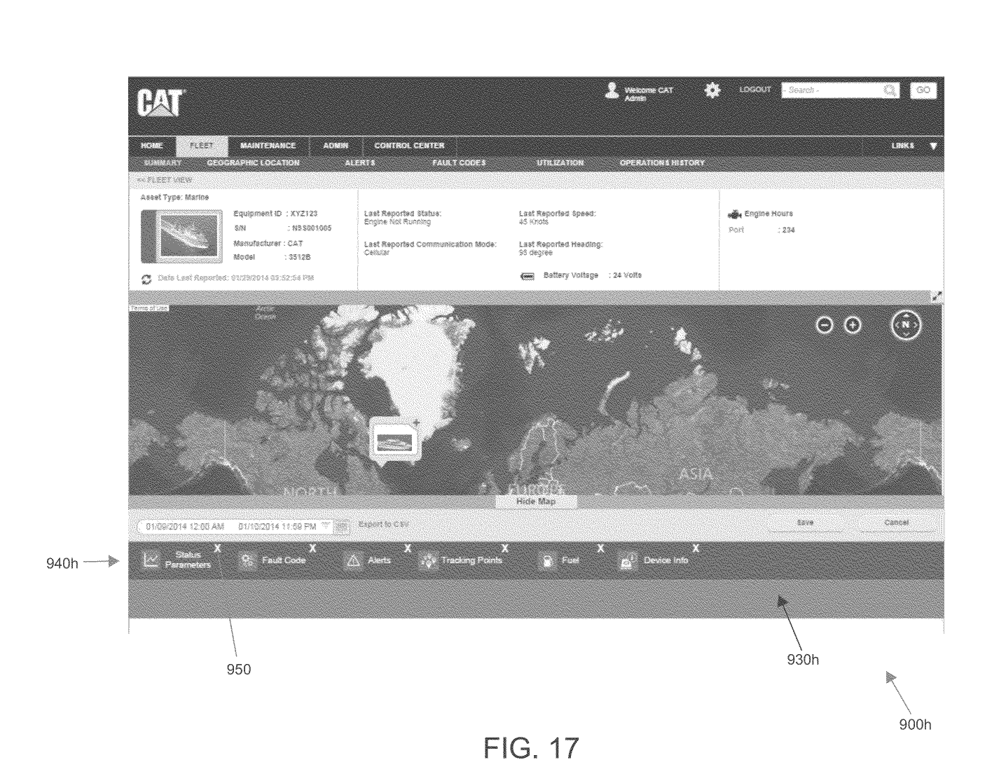

The fleet screen summary page 900g of FIG. 16 may include a configure button 938. In one aspect, if the configure button 938 of FIG. 16 is selected, an updated or refreshed fleet third panel 930h of the fleet screen summary page 900h may be displayed, as shown in FIG. 17. The fleet third panel 930h may display configurable tabs or menu buttons 940h. The configurable tabs or menu buttons 940h may include one or more of the following buttons: status parameter menu button, a fault code menu button, an alerts menu button, a tracking points menu button, a fuel menu button, a device info button, a power menu button, and an equipment menu button. Each of the menu options from the configurable tabs or menu buttons 940h may include a selectable icon 950 to delete or remove an associated tab or menu button from the configurable tabs or menu buttons 940h of the fleet third panel 930h. The selectable icon 950 may include an “X” symbol, however, depictions or symbols for the selectable icon 950 are of course contemplated.

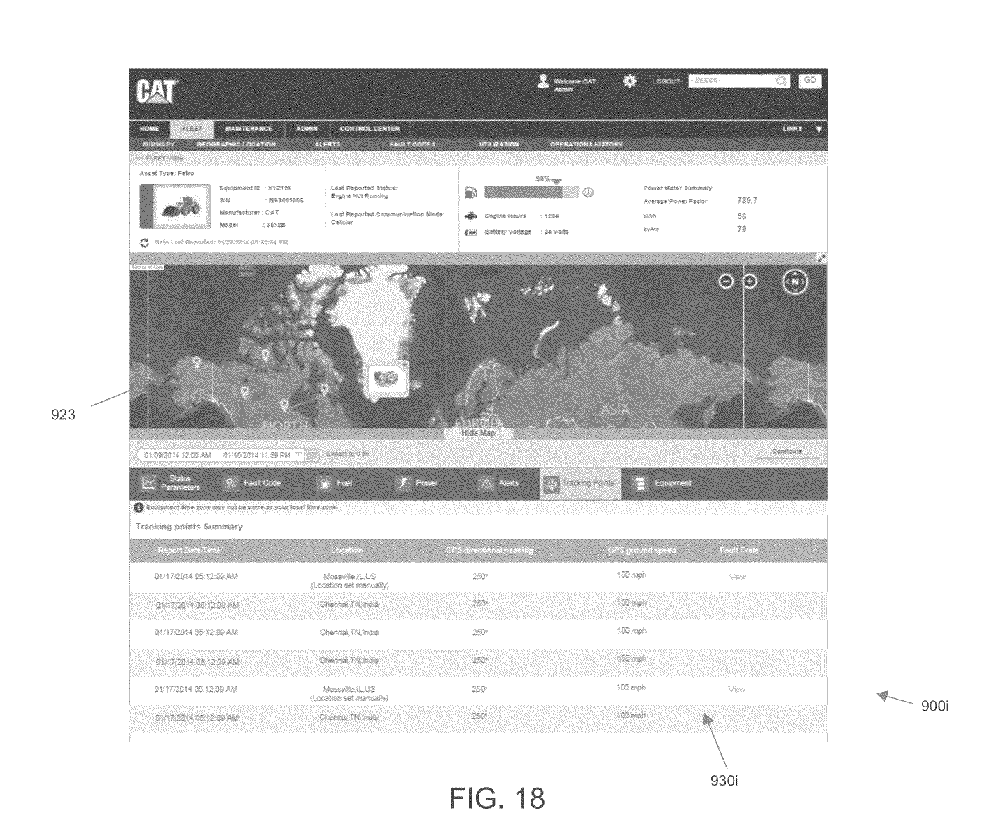

Turning to FIG. 18, when the tracking points menu button 946 (as shown in FIG. 9) is selected, tracking points summary information relating to the currently selected asset or piece of equipment may be displayed in an updated or refreshed fleet third panel 930i of the fleet screen summary page 900i. In one aspect, the fleet third panel 930i may include a chart showing tracking points summary information for one or more pieces of equipment associated with the currently selected asset or piece of equipment. In one aspect, the chart may include one or more of the following fields: report date/time, location, GPS directional heading, GPS ground speed, and fault code. Additionally, corresponding markers may be displayed on an updated map in the fleet second panel 920i. Each marker 923 may correspond to a separate entry listed in the chart of the tracking points summary information of the fleet third panel 930i.

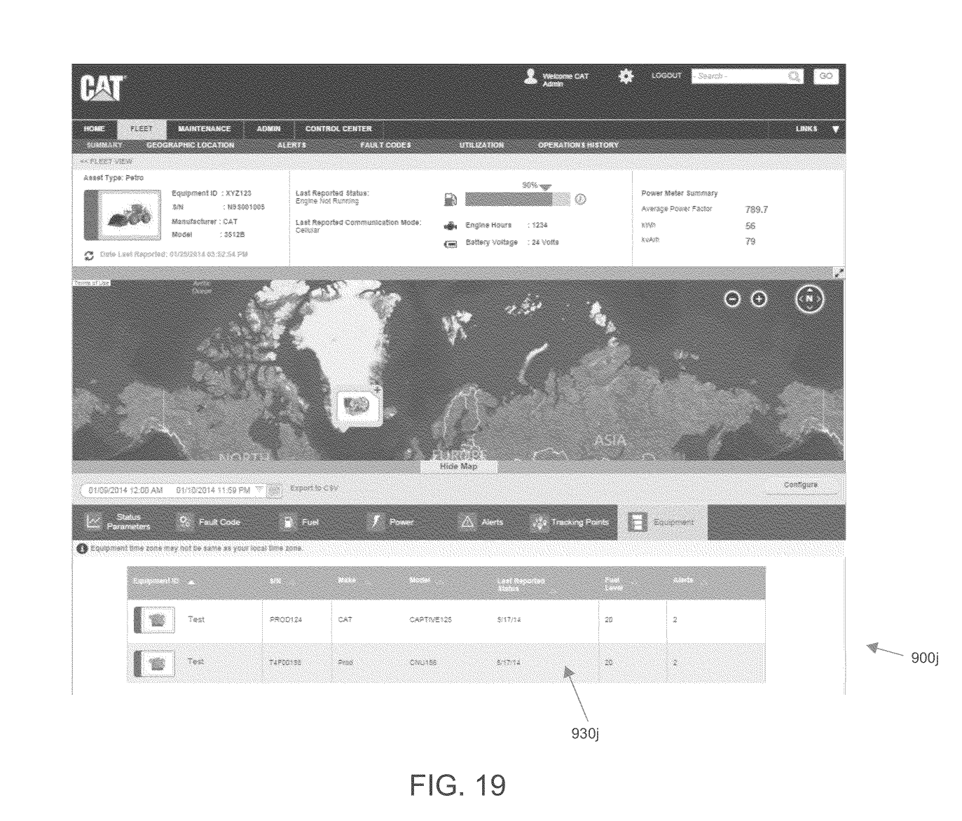

Turning to FIG. 19, when the equipment menu button 947 (as shown in FIG. 9) is selected, equipment information relating to the currently selected asset may be displayed in an updated or refreshed fleet third panel 930j of the fleet screen summary page 900j. In one aspect, the fleet third panel 930j may include a chart showing equipment information for the currently selected asset, which may include one or more of the following fields: equipment identification (ID), serial number, make, model, last reported status, fuel level, and alerts.

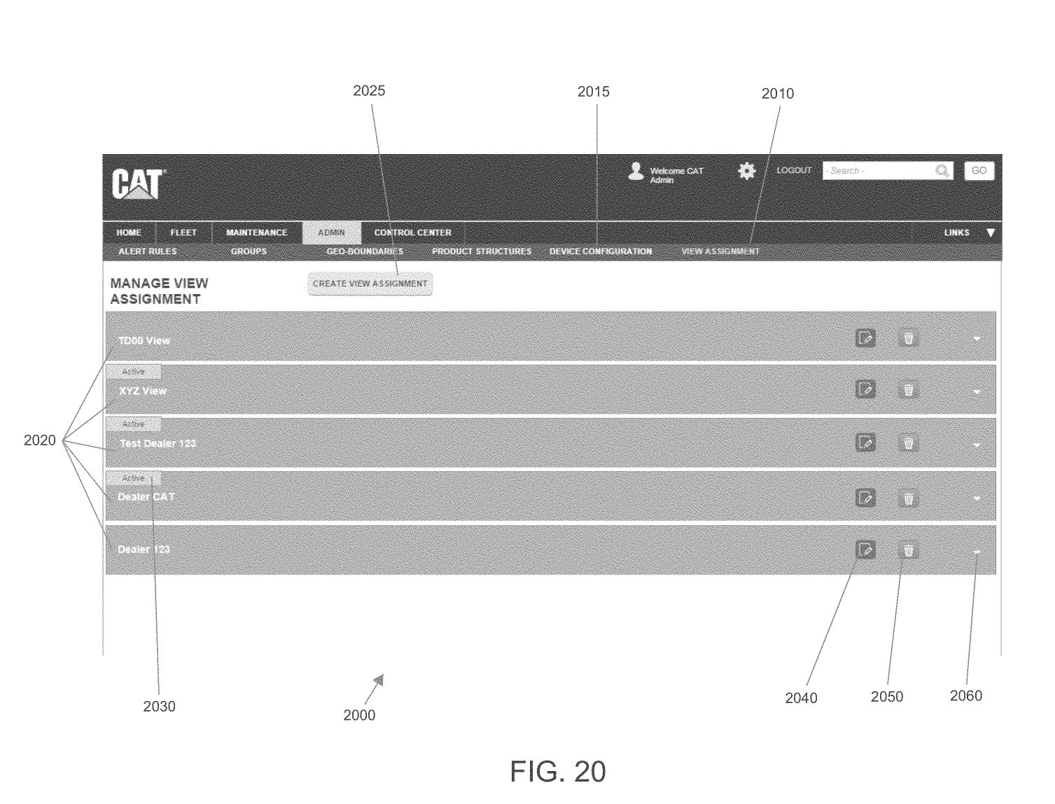

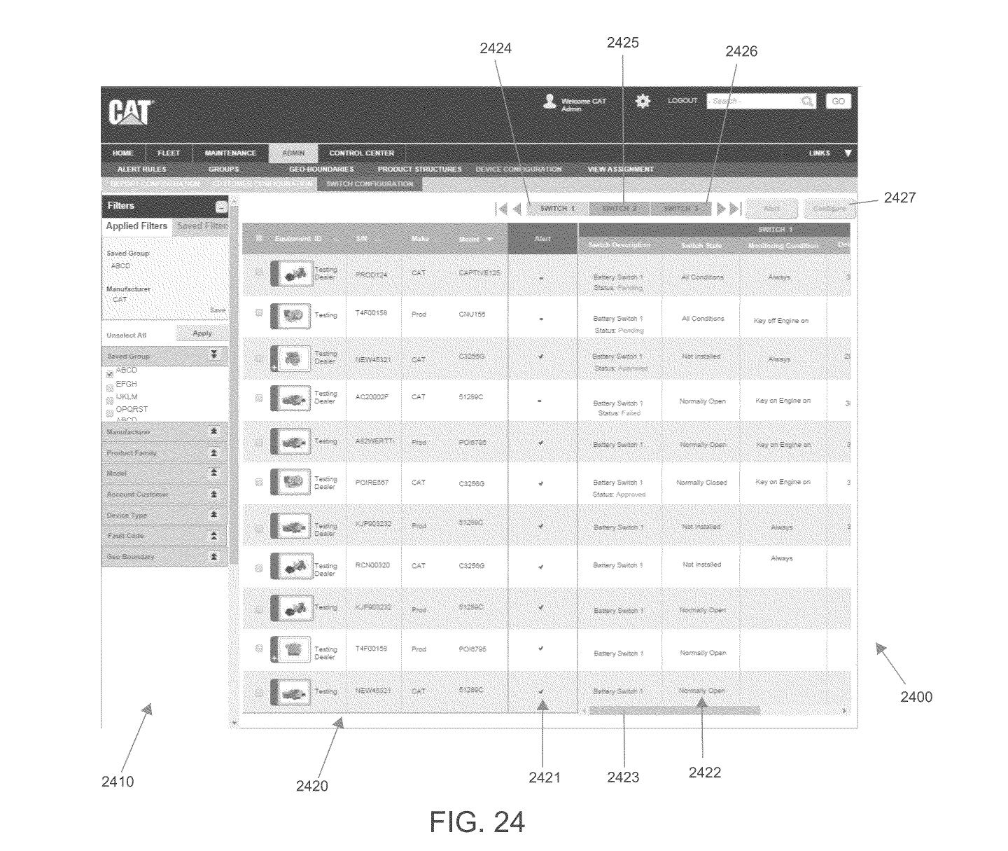

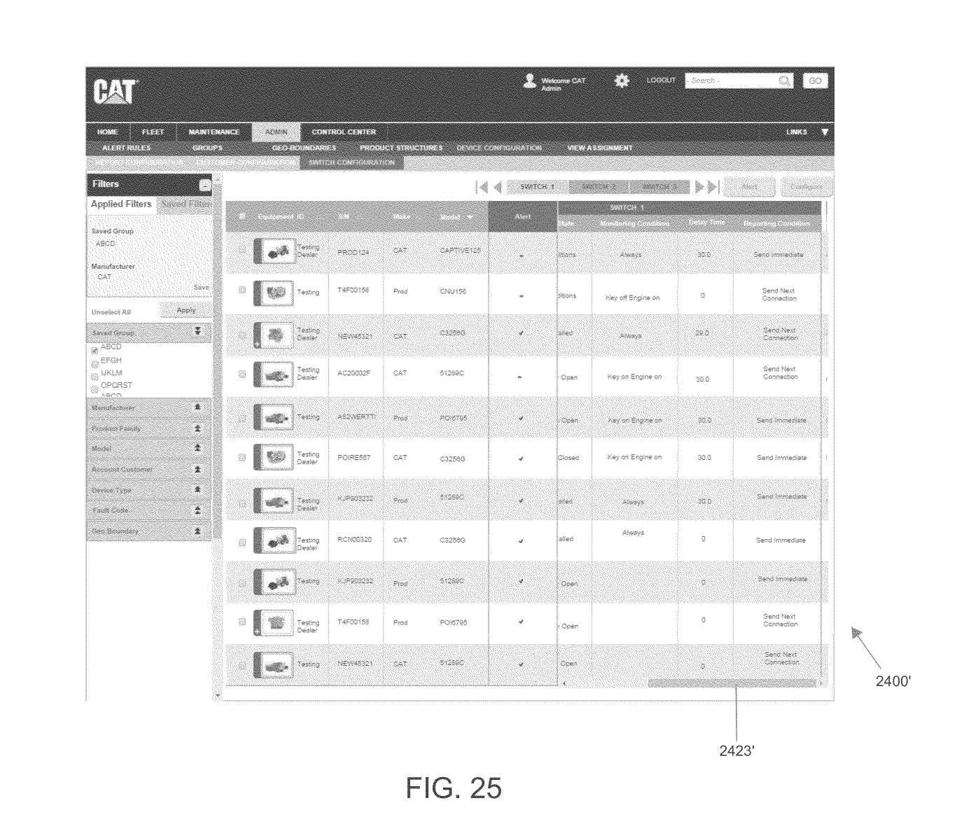

As shown in FIG. 20, a manage view assignment page 2000 may be accessed by selecting the admin button 114 from at least the home screen page 100 (as shown in FIG. 1), and/or selecting a view assignment button 2010 while on an administrative screen page. In one aspect, the manage view assignment page 2000 may include one or more view assignment entries 2020, and the one or more view assignment entries 2020 may be selected to provide additional information relating to that particular view assignment entry 2020. In one aspect, the view assignment entry 2020 may include a label 2030 to indicate whether that particular view assignment entry 2020 is currently active. In one aspect, the label 2030 may include a yellow rectangular box with the description “Active,” however, other shapes, color, and description are of course contemplated. In one aspect, the manage view assignment page 2000 may include a create view assignment button 2025 to open a pop-up window or redirect to a new screen for creating additional view assignment entries. In one aspect, the manage view assignment page 2000 may include a device configuration button 2015 for device configuration operations as will be described in detail further below with reference to FIGS. 24 and 25.

In one aspect, each of the view assignment entries 2020 may include a first button 2040, a second button 2050, and a third button 2060. The first button 2040 may activate or redirect a user to a screen for editing the selected view assignment entry 2020. In one aspect, the first button 2040 may include an icon with a pen or pencil. The second button 2050 may be selected to delete the selected view assignment entry′ 2020, and may further activate a pop up to ask a user to confirm whether or not the selected view assignment entry 2020 should be deleted. In one aspect, the second button 2050 may include an icon with a trash can. The third button 2060 may be used to expand the selected view assignment entry 2020 to display additional information relating to the selected view assignment entry 2020. The third button 2060 may include an icon with a downward arrow or triangle. Other depictions, icons, or images for the first button 2040, second button 2050, and third button 2060 are of course contemplated.

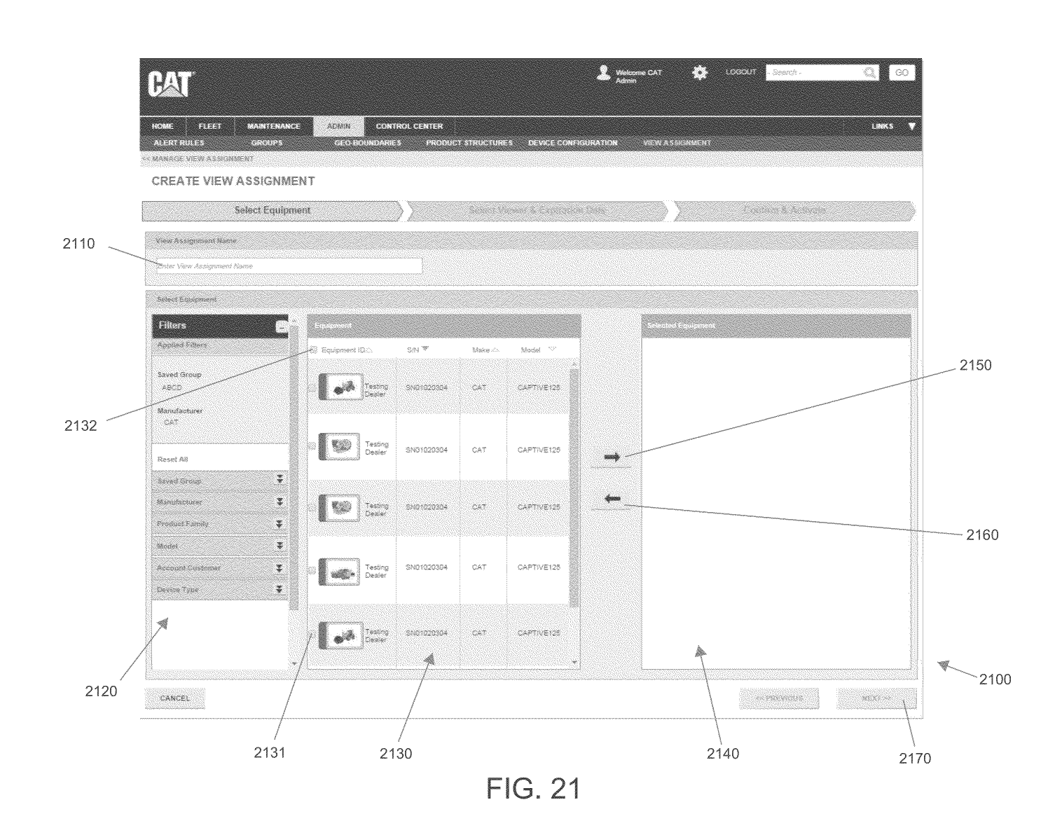

As shown in FIG. 21, an edit view assignment page 2100 may be accessed by selecting the first button 2040 on the manage view assignment page 2000 (shown in FIG. 20) for a particular view assignment of interest. The edit view assignment page 2100 may include a view assignment name entry field 2110, a filter panel 2120, an equipment selection panel 2130, and a selected equipment panel 2140. In one aspect, the name entry field 2110 may be in the form of a text box for entering alphanumeric characters, which may be used to input or edit a name for the selected view assignment. In one aspect, the filter panel 2120 may include a list of filter selections for narrowing down a list of equipment accessible to a current user, the list of equipment being selectable to be associated with the selected view assignment. In one aspect, the filter panel 2120 may include one or more of the following filter options or categories: saved group, manufacturer, product family, model, account customer, and device type.

In one aspect, the list of equipment available for selection may be displayed in the equipment selection panel 2130. The equipment selection panel 2130 may display the list of equipment with one or more of the following identifiers: equipment identification (ID), serial number, make, and model. In one aspect, each piece of equipment available for selection may include a respective check box 2131. In one aspect, the equipment selection panel 2130 may include a select all check box 2132 to select all available equipment listed in the equipment selection panel 2130. Once equipment has been selected in the equipment selection panel 2130, an add button 2150 may be selected by a user to add the selected equipment to the selected equipment panel 2140. Equipment that have been selected and appearing in the selected equipment panel 2140 may also be removed by selecting the equipment to be removed and then selecting a remove button 2160. Once the desired equipment has been added to the selected equipment panel 2140, a next button 2170 may be selected to advance to a next step of the view assignment process.

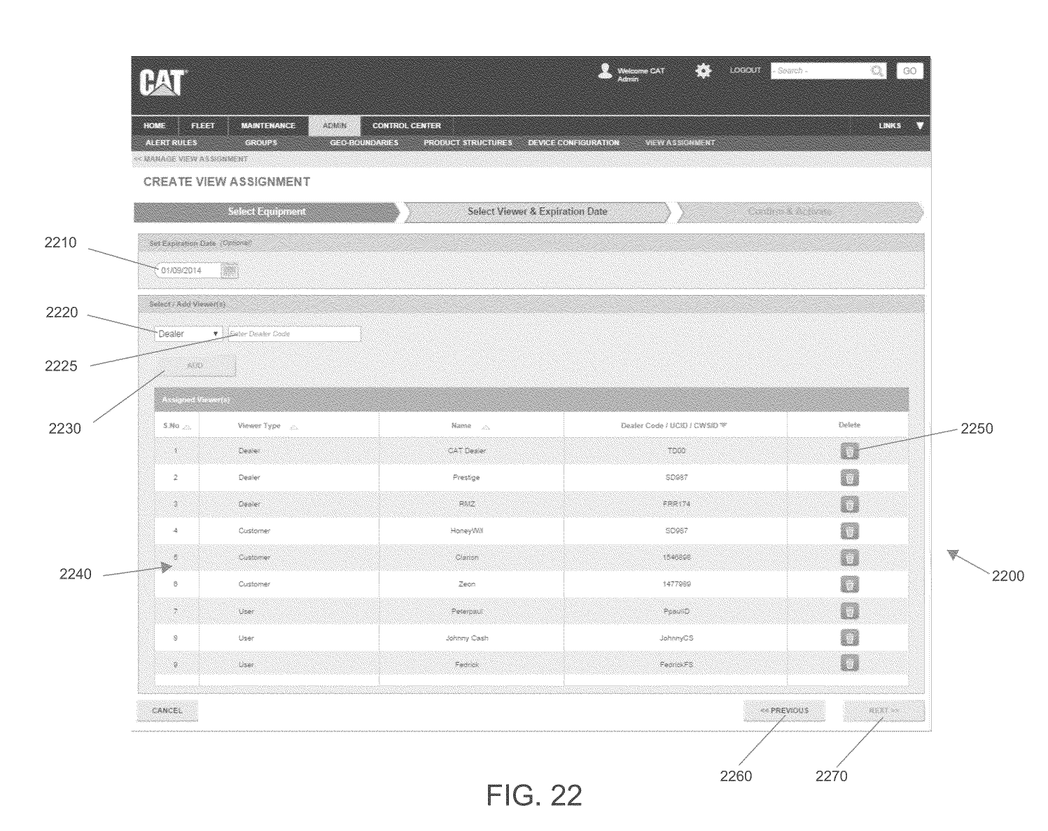

As shown in FIG. 22, an expiration and viewer selection page 2200 may be accessed by selecting the next button 2170 (as shown in FIG. 21), The expiration and viewer selection page 2200 may include an expiration date selector 2210, a viewer type selector 2220, and an assigned viewer panel 2240. The expiration date selector 2210 may include a text input to enter a calendar date for which the view assignment is to expire, and/or the expiration date selector 2210 may include a graphical calendar pop-up for a user to graphically select an expiration date. The viewer type selector 2220 may include a drop down menu to select from different types of viewers, which may include dealers, customers, and/or users. A viewer code entry box 2225 may be provided for entry of a viewer identification code, and the identification code may be in an alpha-numeric and/or symbol format.

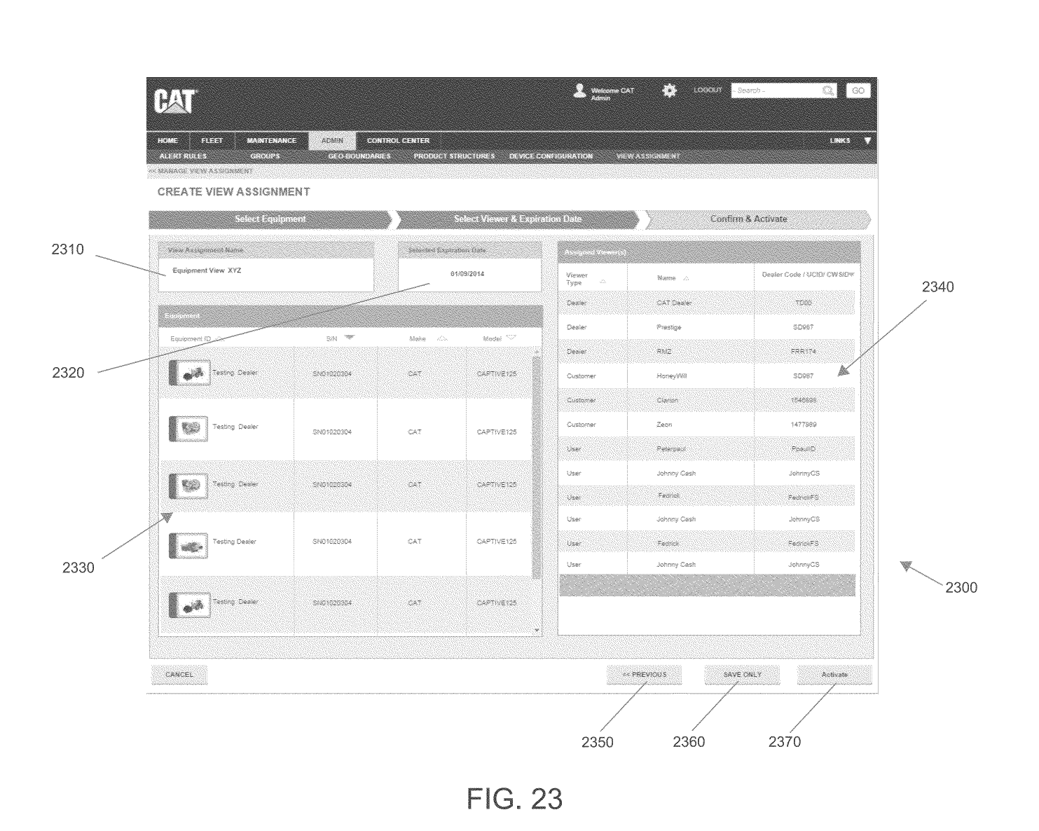

In one aspect, once a viewer type has been selected in the viewer type selector 2220 and a viewer code has been entered into entry box 2225, an add button 2230 may be selected to add the respective viewer to the assigned viewer panel 2240. Each unique viewer listed in the assigned viewer panel 2240 may be removed by selecting an associated delete button 2250, if desired. Once the desired list of viewers has been populated in the assigned viewer panel 2240, a next button 2270 may be selected to advance to a confirmation step of the view assignment process, as will be described with reference to FIG. 23. Alternatively, a previous button 2260 may be selected to return to the previous edit view assignment page 2100, as shown in FIG. 21.

As shown in FIG. 23, a view assignment confirmation page 2300 may be accessed by selecting the next button 2270 (as shown in FIG. 22). The view assignment confirmation page 2300 may display one or more of a view assignment name section 2310, a selected expiration date section 2320, a selected equipment panel 2330, and an assigned viewer panel 2340. In one aspect, the selected equipment panel 2330 may display a list of equipment including equipment identification (ID), serial number, make, and model. The equipment displayed in the selected equipment panel 2330 may correspond to the equipment added to the selected equipment panel 2140 of FIG. 21.

In one aspect, the assigned viewer panel 2340 may display a list of viewers identified by one or more of a viewer type, a name, a dealer code, an universal customer identification (UCID) code, and a corporate web security identification (CWSID) code. Once a desired list of equipment, shown in selected equipment panel 2330, and a desired list of viewers, shown in the assigned viewer panel 2340 is confirmed, a save only button 2360 may be selected to save the current view assignment parameters. Alternatively, the activate button 2370 may be selected to activate and enable the selected view assignments. In one aspect, once the selected view assignments have been activated, the viewers listed in the assigned viewer panel 2340 will have access to information relating to the equipment listed in the selected equipment panel 2330. If selected, the access to the information will be enabled until the expiration date listed in the selected expiration date section 2320 has been reached. As an alternative to selecting the save only button 2360 or the activate button 2370, a previous button 2350 may be selected to return to the previous expiration and viewer selection page 2200, as shown in FIG. 22.

As shown in FIG. 24, and with reference to FIGS. 1 and 20, a switch configuration page 2400 may be accessed by selecting the admin button 114 from at least the home screen page 100 (as shown in FIG. 1), and/or selecting a device configuration button 2015 while on the manage view assignment page 2000 page (as shown in FIG. 20). One or more telematics sensors or detectors including on/off switches may be installed on an asset or equipment of the fleet. The switches of these telematics sensors or detectors may then be configured on the switch configuration page 2400 to provide alerts when there is a change in state. For example, a fire sensor may be installed on a piece of equipment and a switch of the fire sensor may be triggered to an “on” state when a fire event is detected. The switch configuration page 2400 may allow a user to set or review switch information and alert conditions, such as when the alert conditions are monitored and when an alert report should be sent.

In one aspect, the switch configuration page 2400 may include a filter panel 2410 and a switch configuration panel 2420. In one aspect, the filter panel 2410 may include a list of filter selections for narrowing down a list of equipment for a switch configuration to be reviewed or adjusted. In one aspect the filter selections of the filter panel 2410 may include one or more of the following selectable filter options or categories: saved group, manufacturer, product family, model, account customer, device type, fault code, and geographic or geo boundary.

In one aspect, the list of equipment where a switch configuration is to be performed may be displayed in the switch configuration panel 2420. The switch configuration panel 2420 may display the list of equipment identified by one or more of: equipment identification (ID), serial number, make, and model. The switch configuration panel 2420 may further include an alert column 2421 to indicate whether an alert is approved and/or currently active for each piece of equipment listed in the switch configuration panel 2420. The switch configuration panel 2420 may further include a switch sub-section 2422 to display switch configuration information.

As shown in FIGS. 24 and 25, the switch sub-section 2422 may display switch information including one or more of: switch description, switch state, monitoring condition, delay time, and reporting condition. In one aspect, the switch sub-section 2422 may be dynamically oriented with respect to other portions of the switch configuration panel 2420. In one aspect, the switch sub-section 2422 may include a horizontal scroll bar 2423 for re-orienting the switch sub-section 2422 to show or hide columns of switch information, as shown in FIG. 25 with an updated or refreshed switch configuration page 2400′ and updated position of a horizontal scroll bar 2423′. Depending on a screen size of the user's display device, one or more columns of the switch information may be displayed with other portions of the switch configuration panel 2420.

In one aspect, the switch configuration panel 2420 may include a first switch button 2424, a second switch button 2425, and a third switch button 2426. Switch information parameters including, but not limited to, switch description, switch state, monitoring condition, display time and/or reporting condition may be predefined and associated with each of the first switch button 2424, the second switch button 2425, and the third switch button 2426. In one aspect, one of the first switch button 2424, the second switch button 2425, and the third switch button 2426 may be selected, and the configure button 2427 may then be selected to configure switch information parameters for that particular switch button. The switch information parameters may then be adjusted for each piece of equipment displayed in the switch configuration panel 2420.

In one aspect, the switch state parameter may include one or more of the following selections: all conditions, normally open, normally closed, and not installed. In one aspect, the monitoring condition parameter may include one or more of the following selections: always, key on, key off, engine on, and engine off. In one aspect, the delay time parameter may include a numerical time selection. For example, the delay time parameter may include a minute(s) selection from 0 to 60. In one aspect, the reporting condition parameter may include one or more of the following selections: send immediate and send next connection.

It should be understood that buttons in FIGS. 2 and 4-25, which are similar to those of the home button 111, the fleet button 112, the maintenance button 113, the administrative or admin button 114, and the control center button 115 shown on the home screen page 100 (as shown in FIG. 1) may be used to access or link to the same or similar pages.

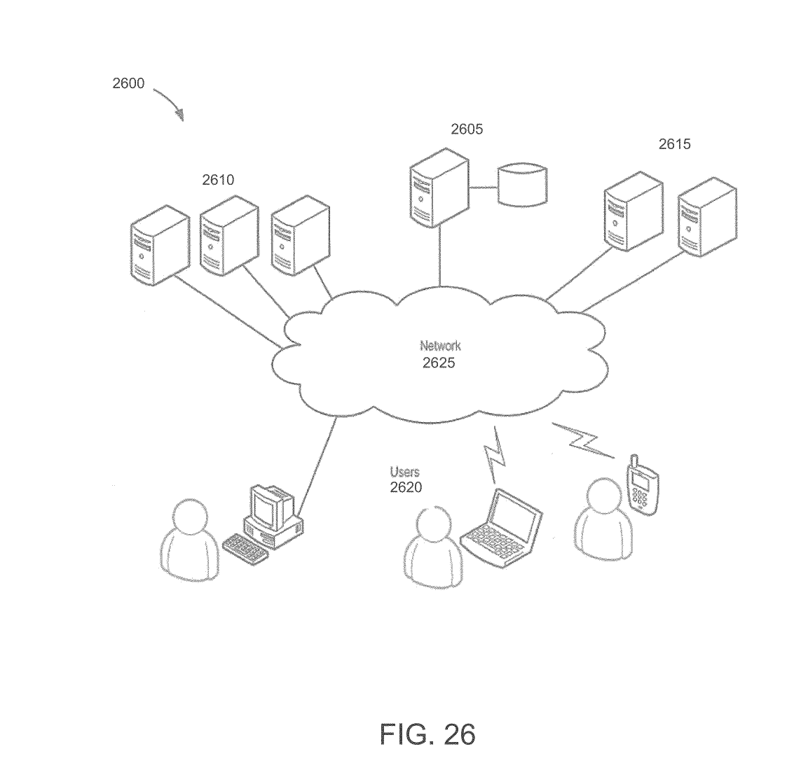

FIG. 26 is a block diagram of an exemplary fleet management system 2600. The fleet management system 2600 may include a web portal system 2605, a first fleet of equipment 2610, a second fleet of equipment 2615, and users 2620. The first fleet of equipment 2610 may include one or more pieces of equipment that each includes wired or wireless communication capabilities to report a status or other information pertaining to that piece of equipment. The second fleet of equipment 2615 may include one or more pieces of equipment that each includes wired or wireless communication capabilities to report a status or other information pertaining to that piece of equipment. Of course, additional fleets of equipment for connecting to the fleet management system are contemplated.

In one aspect, the web portal system 2605 may retrieve information from the first fleet of equipment 2610 and/or second fleet of equipment 2615, format the retrieved information into one or more screens, including generation of one or more of the graphical user interfaces discussed above, and transmit the one or more screens to one or more users 2620. In one aspect, the web portal system 2605 may transmit the one or more screens to one or more electronic devices of the users 2620, the electronic devices including at least a display screen.

### INDUSTRIAL APPLICABILITY

The disclosure is applicable to a user interface for a management solution, and more particularly to a user interface for a fleet management web portal to manage a fleet of machines and/or equipment.

FIGS. 1-25 show user interfaces for the fleet management web portal that may be displayed on an electronic device to allow a user to view and manage alerts associated with a fleet of equipment that is linked to the fleet management web portal.

In one aspect, the fleet management web portal may include an interactive interface and/or database which may be hosted on one or more servers located at one or more sites. The fleet management web portal may be used to store, receive and/or distribute data and information relating to a single piece of machine or equipment, or a fleet of machines and equipment. The fleet management web portal may enable operators to access up-to-date and relevant information relating to their equipment to improve operating efficiency and reduce cost.

In one aspect, the fleet management web portal may be accessed with an electronic device, such as but not limited to, a desktop computer, a laptop, a tablet, a mobile phone, computing devices, mobile smartphones, etc. The electronic device may include at least a display screen and at least one input device. Referring to FIGS. 1-25, the user interfaces may include alerts overlaid on top of geographic information, such as a map, for easy identification by a user. In one aspect, the user interfaces of FIGS. 1-25 may include a variety of inputs such as text box inputs, check boxes, radio buttons, drop down menus, and/or sorting via column headers, which may provide intuitive input operation regardless of whether a user is accessing the fleet management web portal through a desktop computer or through a mobile device such as a mobile phone or tablet.

In one aspect, referring to FIGS. 4 and 5, a fleet screen summary page 400 may include a first panel 410, a second panel 420, and a third panel 430 to display information relating to a selected fleet asset or selected piece of equipment. The first panel 410, the second panel 420, and the third panel 430 may be stacked vertically on top of one another. The first panel 410 may be horizontally arranged such that the equipment information may be displayed simultaneously on the user's display device screen, and the third panel 430 may be horizontally arranged in order for all the device information associated with a piece of equipment to be displayed together within the user's display device screen.

In one aspect, as shown in FIG. 15, left toggle button 948 and/or right toggle button 949 may be provided in the fleet third panel 930f to laterally scroll through the available tabs or menu buttons when a total width of all available tabs or menu buttons placed side-by-side exceeds a width of the user's display device screen.

In one aspect, as shown in FIG. 24, switches of telematics sensors or detectors may be configured using the switch configuration page 2400 to provide alerts when there is a change in state. The switch configuration page 2400 may allow a user to set or review switch information and alert conditions, such as when the alert conditions are monitored and when an alert report should be sent. In one aspect, the switch configuration page 2400 may include a filter panel 2410 and a switch configuration panel 2420. The filter panel 2410 may include one or more of the following selectable filter options or categories: saved group, manufacturer, product family, model, account customer, device type, fault code, and geographic or geo boundary. The switch configuration panel 2420 may display the list of equipment identified by one or more of: equipment identification (ID), serial number, make, and model. The switch configuration panel 2420 may further include an alert column 2421 to indicate whether an alert is approved and/or currently active for each piece of equipment listed in the switch configuration panel 2420.

FIG. 26 shows a block diagram of an exemplary fleet management system 2600. The fleet management system 2600 may include a web portal system 2605, a first fleet of equipment 2610, a second fleet of equipment 2615, and users 2620. The first fleet of equipment 2610 may include one or more pieces of equipment that each includes wired or wireless communication capabilities to report a status or other information pertaining to that piece of equipment. The second fleet of equipment 2615 may include one or more pieces of equipment that each includes wired or wireless communication capabilities to report a status or other information pertaining to that piece of equipment. Of course, additional fleets of equipment for connecting to the fleet management system 2600 are contemplated.

The system further includes a web portal system 2605. The web portal system 2605 operates to at least retrieve information from the first and the second fleet of equipment, and to format the retrieved information for display to the users 2620. Each of these entities can be coupled to a network 2625 (e.g., the Internet) using one or more communication channels (e.g., cellular, wireless, optical, Ethernet, satellite).

The functional operations described can be implemented in digital electronic circuitry, or in computer hardware, firmware, software, or in combinations of them. The web portal system 2605 can be implemented in a computer program product tangibly embodied in a machine-readable storage device for execution by a programmable processor. The steps performed by the web portal system 2605 can be performed by a programmable processor executing a program of instructions to perform functions by operating on input data and generating output.

The web portal system 2605 can be implemented in one or more computer programs that are executable on a programmable system including at least one programmable processor coupled to receive data and instructions from, and transmit data and instructions to, a data storage system, at least one input device, and at least one output device. Each computer program can be implemented in a high-level procedural or object-oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; a magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

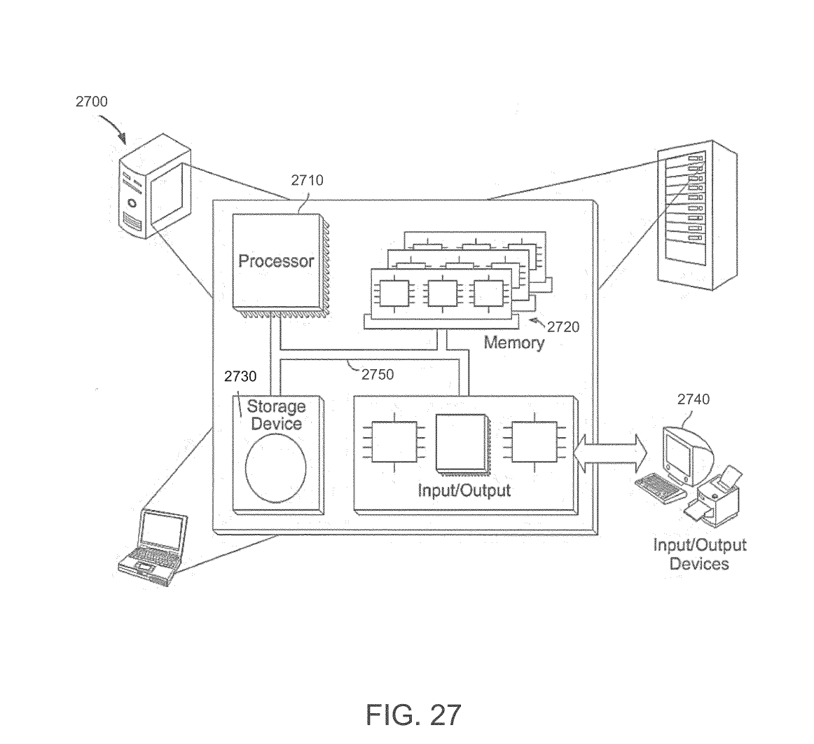

FIG. 27 shows a schematic diagram of an exemplary computer system 2700 that can be used to implement a server hosting the web portal system 2605, the first fleet of equipment 2610, and the second fleet of equipment 2615.

The system 2700 includes a processor 2710, a memory 2720, a storage device 2730, and an input/output device 2740. Each of the components 2710, 2720, 2730, and 2740 can, for example, be interconnected using a system bus 2750. The processor 2710 is capable of processing instructions for execution within the system 2700. In one implementation, the processor 2710 is a single-threaded processor. In another implementation, the processor 2710 is a multi-threaded processor. The processor 2710 is capable of processing instructions stored in the memory 2720 or on the storage device 2730 to display graphical information for a user interface on the input/output device 2740. In some embodiments, a parallel processing set of systems 2700 connected over a network may be employed, clustered into one or more server centers.

The memory 2720 stores information within the system 2700. In one implementation, the memory 2720 is a computer-readable medium. In one implementation, the memory 2720 is a volatile memory unit. In another implementation, the memory 2720 is a non-volatile memory unit.

The storage device 2730 is capable of providing mass storage for the system 2700. In one implementation, the storage device 2730 is a computer-readable medium. In various different implementations, the storage device 2730 can, for example, include a hard disk device, an optical disk device, or some other large capacity storage device.

The input/output device 2740 provides input/output operations for the system 2700. In one implementation, the input/output device 2740 may include one or more of a keyboard, a mouse, a button, a touchpad, a touchscreen, or the like. In another implementation, the input/output device 2740 includes a display unit for displaying graphical user interfaces (GUI) of the fleet management system 2700.

In one aspect, the user interfaces of this disclosure may include or may be usable with communication channels that may be any type of wired or wireless electronic communications network, such as, e.g., a wired/wireless local area network (LAN), a peer-to-peer network (P2P), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), using known protocols such as the Global System for Mobile Communications (GSM), CDMA (Code-Division Multiple Access), W-CDMA (Wideband Code-Division Multiple Access), Wireless Fidelity (Wi-Fi), Bluetooth, Long Term Evolution (LTE), EVolution-Data Optimized (EVDO) and/or the like, and/or a combination of two or more thereof.

The user interfaces of this disclosure may be implemented in any type of computing devices, such as, e.g., a desktop computer, personal computer, a laptop/mobile computer, a personal data assistant (PDA), a mobile phone, a tablet computer, cloud computing device, and the like, with wired/wireless communications capabilities via the communication channels.

In one aspect, the user interfaces of this disclosure may be web-based. For example, a server may operate a web application to allow the user interfaces to operate in conjunction with a database. The web application may be hosted in a browser-controlled environment (e.g., a Java applet and/or the like), coded in a browser-supported language (e.g., JavaScript combined with a browser-rendered markup language (e.g., Hyper Text Markup Language (HTML) and/or the like)) and/or the like such that any computer running a common web browser (e.g., Internet Explorer™, Firefox™, Chrome™, Safari™ or the like) may render the application executable. A web-based service may be more beneficial due to the ubiquity of web browsers and the convenience of using a web browser as a client (i.e., thin client). Further, with inherent support for cross-platform compatibility, the web application may be maintained and updated without distributing and installing software on each.

In one aspect, the user interfaces of this disclosure may be implemented in any type of mobile smartphones that are operated by any type of advanced mobile data processing and communication operating system, such as, e.g., an Apple™ iOS™ operating system, a Google™ Android™ operating system, a RIM™ Blackberry™ operating system, a Nokia™ Symbian™ operating system, a Microsoft™ Windows Mobile™ operating system, a Microsoft™ Windows Phone™ operating system, a Linux™ operating system or the like.

Further in accordance with various aspects of the user interfaces of this disclosure, the methods described herein are intended for operation with dedicated hardware implementations including, but not limited to, PCs, PDAs, semiconductors, application specific integrated circuits (ASIC), programmable logic arrays, cloud computing devices, and other hardware devices constructed to implement the methods described herein.

It should also be noted that the software implementations of the user interfaces of this disclosure as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the user interfaces of this disclosure is considered to include a tangible storage medium or distribution medium, as listed herein and including art-recognized equivalents and successor media, in which the software implementations herein are stored.

Additionally, the various aspects of the user interfaces of this disclosure may be implemented in a non-generic computer implementation. Moreover, the various aspects of the user interfaces of this disclosure set forth herein improve the functioning of the system as is apparent from the user interfaces of this disclosure hereof. Furthermore, the various aspects of the user interfaces of this disclosure involve computer hardware that it specifically programmed to solve the complex problem addressed by the user interfaces of this disclosure. Accordingly, the various aspects of the user interfaces of this disclosure improve the functioning of the system overall in its specific implementation to perform the process set forth by the user interfaces of this disclosure and as defined by the claims.

It will be appreciated that the foregoing description provides examples of the disclosed system and technique. However, it is contemplated that other implementations of the user interfaces of this disclosure may differ in detail from the foregoing examples. All references to the user interfaces of this disclosure or examples thereof are intended to reference the particular example being discussed at that point and are not intended to imply any limitation as to the scope of the user interfaces of this disclosure more generally. All language of distinction and disparagement with respect to certain features is intended to indicate a lack of preference for those features, but not to exclude such from the scope of the user interfaces of this disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

What is claimed is:

1. A display device for displaying a graphical user interface of a management system, the graphical user interface comprising:
a first screen configured to display a first panel, a second panel, and a third panel with fleet information; and
one or more selection buttons or links configured to access at least a second screen, the second screen being configured to facilitate management of one or more pieces of equipment associated with a fleet, the second screen including a panel having a plurality of menu buttons including at least one of a status parameter menu button, a fault code menu button, a fuel menu button, a power menu button, an alerts menu button, a tracking points menu button, and an equipment menu button.

2. The display device for displaying the graphical user interface of claim 1, wherein the first panel of the first screen includes equipment summary alerts and equipment operating parameters.

3. The display device for displaying the graphical user interface of claim 1, wherein the first panel of the first screen includes at least one of a total fuel usage, a total power usage, and a total number of alerts.

4. The display device for displaying the graphical user interface of claim 1, wherein the second panel of the first screen includes a map with equipment information overlaid on the map.

5. The display device for displaying the graphical user interface of claim 1, wherein the third panel of the first screen includes a list of alert type categories and a numerical count of each alert type that has an active alert, and
wherein the list of alert type categories includes at least one of fault codes, geographic boundaries, a fuel loss, a fuel level, a device status, an engine status, a low battery voltage, a power loss, and a switch alert.

6. The display device for displaying the graphical user interface of claim 1, wherein the first panel, the second panel, and the third panel of the first screen are vertically oriented with a respective height of each panel being greater than a respective width of each panel.

7. The display device for displaying the graphical user interface of claim 1, wherein the second panel of the first screen is centrally located between the first panel and the third panel.

8. The display device for displaying the graphical user interface of claim 1, wherein the second screen includes a fleet first panel, a fleet second panel, and a fleet third panel.

9. The display device for displaying the graphical user interface of claim 8, wherein the fleet first panel, the fleet second panel, and the fleet third panel are stacked vertically on top of one another.

10. The display device for displaying the graphical user interface of claim 8, wherein the fleet first panel displays land-based machine information including at least one of an equipment identification, a serial number, a manufacturer, a model, a last reported status, a last reported communication mode, a fuel amount, engine hours, a battery voltage, a power meter summary, an average power factor, an energy consumption amount, and a reactive power amount.

11. The display device for displaying the graphical user interface of claim 8, wherein the fleet first panel displays marine-based machine information including at least one of an equipment identification, a serial number, a manufacturer, a model, a last reported status, a last reported communication mode, a last reported speed, a last reported heading direction, a battery voltage, and engine hours.

12. The display device for displaying a graphical user interface of claim 1, further comprising one or more selection buttons or links configured to access at least a third screen, the third screen being configured to facilitate management of switch configurations, and
wherein the third screen includes a filter panel and a switch configuration panel.

13. The display device for displaying a graphical user interface of claim 12, wherein the filter panel includes a plurality of filter options, the plurality of filter options including at least one of a saved group, a manufacturer, a product family, a model, an account customer, a device type, a fault code, and a geographic boundary.

14. The display device for displaying a graphical user interface of claim 12, wherein the switch configuration panel includes at least an equipment information column, an alert column, and a switch information column.

15. A computer-implemented method for displaying a management system through a graphical user interface on a display device, the method comprising:
retrieving information from one or more pieces of equipment associated with the management system;
generating a first screen to display a first panel including equipment information, and to display one or more selection buttons or links configured to access a second screen to facilitate management of one or more pieces of equipment associated with the management system; and
generating the second screen, upon selection of the one or more selection buttons or links configured to access the second screen, to display a panel having at least one of a status parameter menu button, a fault code menu button, a fuel menu button, a power menu button, an alerts menu button, a tracking points menu button, and an equipment menu button.

16. The method of claim 15, wherein the generating the second screen includes displaying a fleet first panel with land-based machine information.

17. The method of claim 16, wherein the land-based machine information includes at least one of an equipment identification, a serial number, a manufacturer, a model, a last reported status, a last reported communication mode, a fuel amount, engine hours, a battery voltage, a power meter summary, an average power factor, an energy consumption amount, and a reactive power amount.

18. The method of claim 15, wherein the generating the second screen includes displaying a fleet first panel with marine-based machine information.

19. The method of claim 18, wherein the marine-based machine information includes at least one of an equipment identification, a serial number, a manufacturer, a model, a last reported status, a last reported communication mode, a last reported speed, a last reported heading direction, a battery voltage, and engine hours.

20. The method of claim 15, further comprising generating a third screen, upon selection of the one or more selection buttons or links configured to access the third screen, the third screen being configured to facilitate management of switch configurations,
wherein the generating the third screen includes displaying a filter panel and a switch configuration panel.
